(19) United States
(12) Patent Application Publication
(10) Pub. No.: US 2025/0300592 A1
(43) Pub. Date: Sep. 25, 2025

(54) ROOFTOP SOLAR PANEL MODULE RACKING SYSTEM AND METHODS OF INSTALLATION THEREOF

(71) Applicant: Unirac, Inc., Albuquerque, NM (US)

(72) Inventor: Jonathan Neal, Albuquerque, NM (US)

(21) Appl. No.: 19/077,759

(22) Filed: Mar. 12, 2025

Related U.S. Application Data
(60) Provisional application No. 63/568,366, filed on Mar. 21, 2024.
(60) Provisional application No. 63/700,899, filed on Sep. 30, 2024.

(51) Int. Cl. H02S 20/23; H02S 20/30; H02S 30/10

(52) U.S. Cl. CPC H02S 20/23; H02S 20/30; H02S 30/10

(57) ABSTRACT

An attachment apparatus includes a rail, that when installed on a mounting surface, is arranged parallel to structural members disposed beneath the mounting surface. The attachment apparatus includes clamps to secure to the rail, the clamps have a stanchion adjustable in height relative to the rail, a receptacle to receive at least a portion of a solar panel module, and a first fastener, that when actuated, secures the at least the portion of the solar panel module within the receptacle. Bushing are secured to the rail, and have at least one through hole to receive a second fastener to secure the rail to the mounting surface.

### CROSS-REFERENCE TO RELATED APPLICATIONS

This application claims priority to U.S. Provisional Patent Application No. 63/568,366, filed Mar. 21, 2024, entitled “Flashing-less Attachment Apparatus and Methods Thereof,” and U.S. Provisional Patent Application No. 63/700,899, filed Sep. 30, 2024, entitled “Attachment Apparatus and Method of Installation Thereof,” the entirety of which are herein incorporated by reference.

### BACKGROUND

The solar power industry continues to grow and, as a result, installation time and integrity remain critical. Generally, mounts that secure solar panel modules to a surface are attached to structural members, such as rafters or trusses. However, locating rafters or trusses below roofing material is time-consuming. In the case where the mounts are attached to non-structural members, such as sheathing, an increased amount of mounts are required to carry the same load. This leads to more penetrations into the surface, which creates a greater potential for leaks.

### BRIEF DESCRIPTION OF THE DRAWINGS

FIG. 1 illustrates an example environment including one or more attachment apparatuses for attaching one or more solar panels to a surface, according to an embodiment of the present disclosure.

FIG. 2 illustrates an example environment including one or more attachment apparatuses for attaching one or more solar panel modules to a surface, according to an embodiment of the present disclosure.

FIG. 3 illustrates an example attachment apparatus for attaching a solar panel module to a surface, according to an embodiment of the present disclosure.

FIG. 4 illustrates an isometric view of an example rail of the attachment apparatus of FIG. 3, according to an embodiment of the present disclosure.

FIG. 5 illustrates an end view of the rail of FIG. 4, according to an embodiment of the present disclosure.

FIG. 6 illustrates an isometric view of an example bushing of the attachment apparatus of FIG. 3, according to an embodiment of the present disclosure.

FIG. 7 illustrates an end view of the bushing of FIG. 6, according to an embodiment of the present disclosure.

FIG. 8 illustrates a bottom view of the bushing of FIG. 6, according to an embodiment of the present disclosure.

FIG. 9 illustrates a cross-sectional view of the bushing of FIG. 6, taken along line A-A of FIG. 7, according to an embodiment of the present disclosure.

FIG. 10 illustrates an isometric view of an example bushing usable with the attachment apparatus of FIG. 3, according to an embodiment of the present disclosure.

FIG. 11 illustrates a cross-sectional view of the bushing of FIG. 10, taken along line B-B of FIG. 10, according to an embodiment of the present disclosure.

FIG. 12 illustrates an isometric view of an example bushing usable with the attachment apparatus of FIG. 3, according to an embodiment of the present disclosure.

FIG. 13 illustrates an isometric view of an example clamp of the attachment apparatus of FIG. 3, according to an embodiment of the present disclosure.

FIG. 14 illustrates a first side view of the clamp of FIG. 13, according to an embodiment of the present disclosure.

FIG. 15 illustrates a second side view of the clamp of FIG. 13, according to an embodiment of the present disclosure.

FIG. 16 illustrates an example engagement between the rail of FIG. 4 and the bushing of FIG. 6, according to an embodiment of the present disclosure.

FIG. 17 illustrates an example engagement between the rail of FIG. 4, the bushing of FIG. 6, and the clamp of FIG. 13, according to an embodiment of the present disclosure.

FIG. 18 illustrates an example engagement between the attachment apparatus of FIG. 3 and a solar panel module, according to an embodiment of the present disclosure.

FIG. 19 illustrates an example rail usable with the attachment apparatus of FIG. 3, according to an embodiment of the present disclosure.

FIG. 20 illustrates an example sequence for attaching the clamp of FIG. 13 to the rail of FIG. 19, according to an embodiment of the present disclosure.

FIG. 21 illustrates an example attachment apparatus for attaching a solar panel module to a surface, according to an embodiment of the present disclosure.

FIG. 22 illustrates an isometric view of a clamp of the attachment apparatus of FIG. 21, according to an embodiment of the present disclosure.

FIG. 23 illustrates a side view of the clamp of FIG. 22, according to an embodiment of the present disclosure.

FIG. 24 illustrates a bottom view of the clamp of FIG. 22, according to an embodiment of the present disclosure.

FIG. 25 illustrates an isometric view of a base of the clamp of FIG. 22, according to an embodiment of the present disclosure.

FIG. 26 illustrates an attachment of the clamp of FIG. 22 to a rail of the attachment apparatus of FIG. 21, according to an embodiment of the present disclosure.

FIG. 27 illustrates an example engagement between the attachment apparatus of FIG. 3 and a solar panel module, according to an embodiment of the present disclosure.

FIGS. 28 and 29 illustrate an example process associated with securing solar panel modules to a surface using the attachment apparatus of FIG. 3 and/or the attachment apparatus of FIG. 21, according to an embodiment of the present disclosure.

FIG. 30 illustrates a side view of an example clamp that may be usable with the attachment apparatus of FIG. 3, according to an embodiment of the present disclosure.

### DETAILED DESCRIPTION

This application is directed, at least in part, to attachment apparatuses that secure one or more solar panel modules to a surface, according to an embodiment of the present disclosure. In an embodiment, the attachment apparatus may include one or more rails, clamps, and/or bushings. The clamps may secure to the solar panel modules and the rails, thereby securing the solar panel modules to the rail. The rails may include a channel in which the bushings are at least partially disposed. The bushings may include one or more cavities in which sealant is disposed for waterproofing the attachment apparatus to the surface. For example, when secured to the surface, the bushings and the sealant may prevent an ingress of liquid into the surface. In an embodiment, the clamps may initially be secured to the rail and then to the solar panel module. As an assembly, the solar panel module, the rail, the clamps, and the bushings may then be installed onto the surface. The use of the attachment apparatus as described herein may reduce installation times and complexities, as well as increase load ratings for solar panel modules.

The rail may represent any suitable track, elongated member, rail, bar, frame, etc. In an embodiment, the rail may resemble a rail on which the clamps are disposed. The rail may include any suitable length to accommodate dimensions of the solar panel modules. For example, in an embodiment, the rail may be sized to span either a longitudinal dimension or a lateral dimension of the solar panel module. In an embodiment, the rail may include a length that is smaller than or longer than either the longitudinal dimension or the lateral dimension of the solar panel module. Moreover, in an embodiment, multiple rails may be secured end-to-end via splices, couplers, etc.

The rail may include first slots that receive first fasteners for securing the clamps to the rail. The first fasteners may be disposed through the first slots and into the clamps for securing the clamps to the rail. In addition, the rail may include second slots that receive second fasteners for securing the rail to the surface. The second fasteners may be disposed through the second slots, through the bushings, and into the surface for securing the rail, as well as the clamps, solar panel modules, etc., to the surface. Any number of first fasteners and the second fasteners may be used. The first slots and second slots may be alternatingly disposed between ends of the rail. The rail may include any number of the first slots and/or the second slots.

The first fasteners and/or the second fasteners may be translatable within the first slots and the second slots, respectively. For example, prior to fully tightening or actuating the first fasteners to the clamps and the second fasteners into the surface, the first fasteners and the second fasteners may translate within the first slots and the second slots, respectively. This translation may accommodate differently sized solar panel modules, align the clamps with features of the solar panel modules, and/or align the bushings on the surface. In an embodiment, the second fasteners may be translatable within the second slots to avoid the bushings being disposed at or along a seam between different courses of shingles, which may adversely impact waterproofing the surface. For example, if the bushing spans two rows of shingles, the bushing may fail to seal against the surface.

In an embodiment, different clamps may be secured to the solar panel modules and the rails. For example, a first type of clamp may represent an end clamp that is disposed on an end of a row of solar panel modules. In an embodiment, the first type of clamp may only secure to one solar panel module. For example, the first type of clamp may include a single receptacle that receives a single solar panel module. Alternatively, a second type of clamp may represent a middle clamp disposed between two adjacent solar panel modules in the row of solar panel modules. The second type of clamp may secure to two solar panel modules. For example, the second type of clamp may include two receptacles, one that receives a first solar panel module and one that receives a second a second solar panel module. The receptacles of the first type of claim and the second type of clamp may accommodate a variety of solar panel modules with different dimensions. Moreover, the first type of clamp and the second type of clamp also may be adjustable in height above the surface.

The first type of clamp and the second type of clamp, as noted above, may be secured to the rail via the first fasteners. In an embodiment, the first type of clamp may include a bracket that secures the first type of clamp to the rail. The first fasteners may be secured into the bracket. A stanchion of the first type of clamp may engage with the bracket. The stanchion also defines a receptacle that receives the solar panel module. In an embodiment, the stanchion of the first type of clamp includes an arm and a platform that define the receptacle. The rail of the solar panel module may be disposed within the receptacle. A fastener may be used to secure the solar panel module within the receptacle. During tightening of the fastener, the rail of the solar panel module becomes secured between the arm and the platform. The stanchion may engage the bracket at various positions depending upon the desired height of the solar panel module.

The second type of clamp may include a base into which the first fasteners are disposed for securing the base to the rail. In an embodiment, the rail to which the second type of clamp is secured and the rail to which the first type of clamp is secured may be similar. The second type of clamp may include a stanchion that engages with the base. The stanchion may be raised to various elevations relative to the base. The stanchion may include a first arm and a second arm on which the two solar panel modules are disposed, respectively. The second type of clamp may also include a bracket secured to the stanchion. The bracket may include a first arm and a second arm. When the bracket secures to the stanchion, a first solar panel module is secured between the first arm of the stanchion and the first arm of the bracket (e.g., within a first receptacle) and a second solar panel module is secured between the second arm of the stanchion and the second arm of the bracket (e.g., within a second receptacle).

The stanchion of the second type of clamp may also include an area for receiving accessories, attachments, etc., or to which the accessories, attachments, etc., are attached. For example, the stanchion may define a slot that receives a fastener. The fastener may be disposed through flanges, brackets, mounts, etc., of the accessory and into the stanchion to attach the accessory to the second type of clamp. The accessories, by way of example, may include wiring harnesses, junction boxes, guards, wind deflectors, etc. Although described as attaching to the second type of clamp, the accessories, attachments, etc., may additionally or alternatively attach to the first type of clamp.

The bushings may include through holes, through which the second fasteners are disposed. In an embodiment, the through holes may extend through an entirety of the bushings. Alternatively, the throughout holes may extend through less than an entirety of the bushings. In such instances, the second fasteners may pierce through a remaining portion of the bushings (e.g., membrane, wall, etc.) when disposed into the surface. The bushings may include a corresponding number of through holes as the second fasteners. In an embodiment, the second fasteners are coated with a sealant, such as butyl. When secured into the surface, penetrations are sealed with the butyl to prevent an ingress of liquid. Alternatively, the sealant may be disposed within the through hole. For example, the sealant may be disposed within at least a portion of the through hole. In an embodiment, the through hole may include different cross-sectional dimensions, areas, portions, etc. For example, a first portion may have a smaller cross-sectional dimension for sealing against the second fasteners, (e.g., around a body thereof) while a second portion may have a larger cross-sectional dimension in which the sealant is disposed. The sealant may represent a flowable sealant, a liquid sealant, an injectable sealant, or an adhesive sealant. In an embodiment, the sealant may be pre-installed or pre-applied within the through hole to reduce installation time and/or complexities.

Regardless of the specific embodiment, as the second fasteners are disposed into the surface, the sealant is drawn at least partially out of the through holes into the surface to seal around the penetrations area created by the second fasteners. In addition, the bushings serve to seal around the penetration area. For example, the bushings may be formed of a material, such as rubber, that is at least partially deformable. When the second fasteners are secured into the surface, the bushings compress and seal against the surface. In an embodiment, the rail of the attachment apparatus may not directly contact the surface. Instead, the bushing may act as a spacer or standoff between the surface and the rail.

In an embodiment, the rail may define a channel in which the bushings are at least partially disposed. Different cross-sectional profiles of the rail are envisioned. In an embodiment, the rail may include sidewalls, flanges, etc., that engage with features of the bushing for securing the bushing to the rail. For example, the bushing may include notches engaged by the sidewalls, flanges, etc., of the rail. An engagement between the notches and the flanges may secure the bushing to the rail. In an embodiment, the bushing may be translated within the channel to align the through holes of the bushings with the second slots, respectively. Once in position adjacent to the second slots, the second fasteners may be at least partially disposed into the through holes, respectively. As noted above, the second fasteners, once attached to the bushings, may be translated during installation within the second slots to avoid the bushing being disposed at a seam between two rows of shingles.

In an embodiment, the rails may be arranged parallel (whether absolutely parallel or generally/substantially parallel) to structural members of the roof, such as rafters, beneath the surface. The second fasteners that secure into the surface may or may not be secured into the structural members. The length of the rail and securement of the second fasteners into the surface along a length of the rail may provide resistance to loads experienced by the solar modules. This distributes the loads experienced by the solar panel modules along the length of the rail. That is, compared to conventional techniques whereby individual mounts (i.e., direct-to-deck mounts, mounting “foot,” etc.) are secured to the surface, use of the clamps positioned along the rail may serve to distribute loads. Moreover, given this arrangement, the second fasteners do not need to be disposed into the structural members.

Use of the attachment apparatus may reduce installation times, complexities, etc. For example, the clamps (whether the first type of clamp or the second type of clamp) may be secured to the rail and the solar panel modules. The bushings may also be secured to the rail. Therein, as an assembly, the solar panel modules may be transported to the surface for installation. Once on the surface, the fasteners may be further disposed through the bushings and secured into the surface. This is in comparison to conventional techniques whereby mounts are independently attached to the surface.

Although the attachment apparatus is described as being a separate component as the solar panel module, in an embodiment, the attachment apparatus may be integrated, whether fully or partially, with the solar panel module. For example, the attachment apparatus and/or the clamps may be integrated within a frame of the solar panel module.

The attachment apparatus may be manufactured from suitable materials and/or manufacturing techniques. In an embodiment, the rail and/or clamps may be manufactured from aluminum, composites, plastics, etc. The rail and/or clamps may also be manufactured via extrusion.

The present disclosure provides an overall understanding of the principles of the structure, function, device, and system disclosed herein. One or more examples of the present disclosure are illustrated in the accompanying drawings. Those of ordinary skill in the art will understand and appreciate that the devices, the systems, and/or the methods specifically described herein and illustrated in the accompanying drawings are non-limiting embodiments. The features illustrated or described in connection with one embodiment or instance may be combined with the features of other embodiments or instances. Such modifications and variations are intended to be included within the scope of the disclosure and appended claims.

The Detailed Description is set forth with reference to the accompanying figures. In the figures, the left-most digit(s) of a reference number identifies the figure in which the reference number first appears. The use of the same reference numbers in different figures indicates similar or identical items. Furthermore, the drawings may be considered as providing an approximate depiction of the relative sizes of the individual components within individual figures. However, the drawings are not to scale, and the relative sizes of the individual components, both within individual figures and between the different figures, may vary from what is depicted. In particular, some of the figures may depict components as a certain size or shape, while other figures may depict the same components on a larger scale or differently shaped for the sake of clarity.

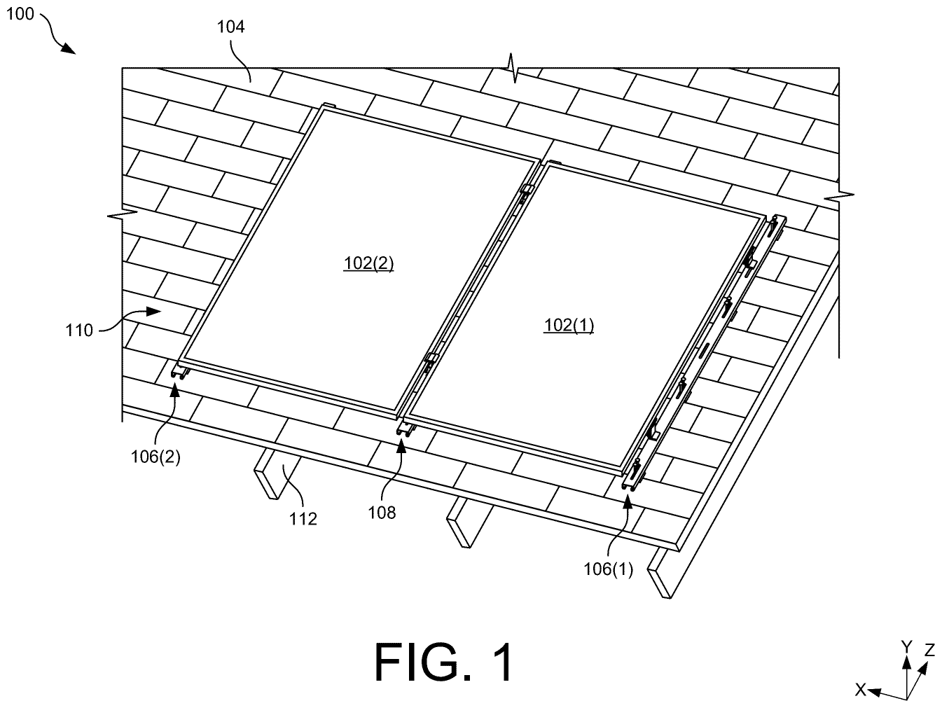

FIG. 1 illustrates an example environment 100 whereby one or more solar panel modules 102 are attached to a roof 104, according to an embodiment of the present disclosure. In an embodiment, the roof 104 may represent a pitched roof. However, although described in use with a pitched roof, the roof 104 may represent flat roofs.

The one or more solar panel modules 102 may be attached to the roof 104 via one or more attachment apparatuses. For example, a first solar panel module 102(1) may be attached to the roof 104 via an attachment apparatus 106(1) and an attachment apparatus 108. A second solar panel module 102(2) may be attached to the roof 104 via the attachment apparatus 108 and an attachment apparatus 106(2). As shown, the attachment apparatus 106(1) and the attachment apparatus 106(2) may be disposed on ends of a row 110 of the solar panel modules 102. The attachment apparatus 106(1) and the attachment apparatus 106(2) may attach to only a single solar panel module. The attachment apparatus 106(1) and the attachment apparatus 106(2) may be the same. Comparatively, the attachment apparatus 108 may be disposed between two of the solar panel modules 102 and attached to multiple solar panel modules 102. For example, the attachment apparatus 108 may attach to the first solar panel module 102(1) and the second solar panel module 102(2).

The attachment apparatus 106(1) may attach to a first side of the first solar panel module 102(1), the attachment apparatus 108 may attach to a second side of the first solar panel module 102(1), as well as a first side of the second solar panel module 102(2), and the attachment apparatus 106(2) may attach to a second side of the second solar panel module 102(2). As will be explained herein, the attachment apparatus 106 and the attachment apparatus 108 may be similar. For example, the attachment apparatus 106 and the attachment apparatus 108 may secure into the roof 104 via one or more fasteners and may attach to the solar panel modules 102 via one or more clamps. The clamps, however, may be different between the attachment apparatus 106 and the attachment apparatus 108. The clamps of the attachment apparatus 106 may support a single solar panel module in the row 110, while the clamps of the attachment apparatus 108 may support more than one solar panel module in the row 110. Details of the different clamps for the attachment apparatus 106 and the attachment apparatus 108 are discussed herein.

In an embodiment, the attachment apparatus 106 and the attachment apparatus 108 may include a rail that is arranged parallel (whether absolutely parallel or generally/substantially parallel) to rafters 112 disposed beneath the roof 104. The rail may be disposed along a lengthwise direction (e.g., in the Z-direction) of the solar panel modules 102, whereby the solar panel modules 102 are arranged in portrait orientation on the roof 104. In an embodiment, the solar panel modules 102 may not be supported along their widthwise direction (e.g., in the X-direction). Fasteners may be disposed through the rail and into the roof 104. The fasteners that secure the attachment apparatus 106 and/or the attachment apparatus 108 to the roof 104 do not need to be secured into the rafters 112. Rather, the elongated nature of the rail allows for longitudinal distribution of the load to the roof 104 and thereby reduces the force of the load to the roof 104. In an embodiment, each of the attachment apparatus 106 and the attachment apparatus 108 may be secured into the roof 104 at different locations. Moreover, the use of multiple attachment points into the roof 104 may distribute the environmental loads experienced by the solar panel modules 102 along a length of the rail.

Although described herein as an attachment apparatus, the attachment apparatus 106 and/or the attachment apparatus 108 may alternatively be referred to as a mounting system, device, assembly, mechanism, etc. Additionally, although referred to as clamps, the attachment apparatus 106 and/or the attachment apparatus 108 may include other mounts, brackets, couplers, etc., that to attach the solar panel modules. As such, the attachment apparatus 106 and/or the attachment apparatus 108 may include additional or alternative components than described herein.

FIG. 1 illustrates two of the solar panel modules 102 being attached to the roof 104, however, more than or less than two of the solar panel modules 102 may be attached to the roof 104. For example, a single solar panel module may be attached to the roof 104. In such instances, two of the attachment apparatuses 106 (e.g., the attachment apparatus 106(1) and the attachment apparatus 106(2)) may be secured to opposing sides of the single solar panel module. The attachment apparatus 108 may be omitted in such instances. Alternatively, if three solar panel modules 102 are attached to the roof 104, two of the attachment apparatuses 108 may be used, along with two of the attachment apparatuses 106. For example, the attachment apparatuses 106 may be disposed on ends of the row 110 (e.g., the first solar panel module and the third solar panel module), a first of the attachment apparatuses 108 may support the first solar panel module and a second solar panel module, and a second of the attachment apparatuses 108 may support the second solar panel module and the third solar panel module.

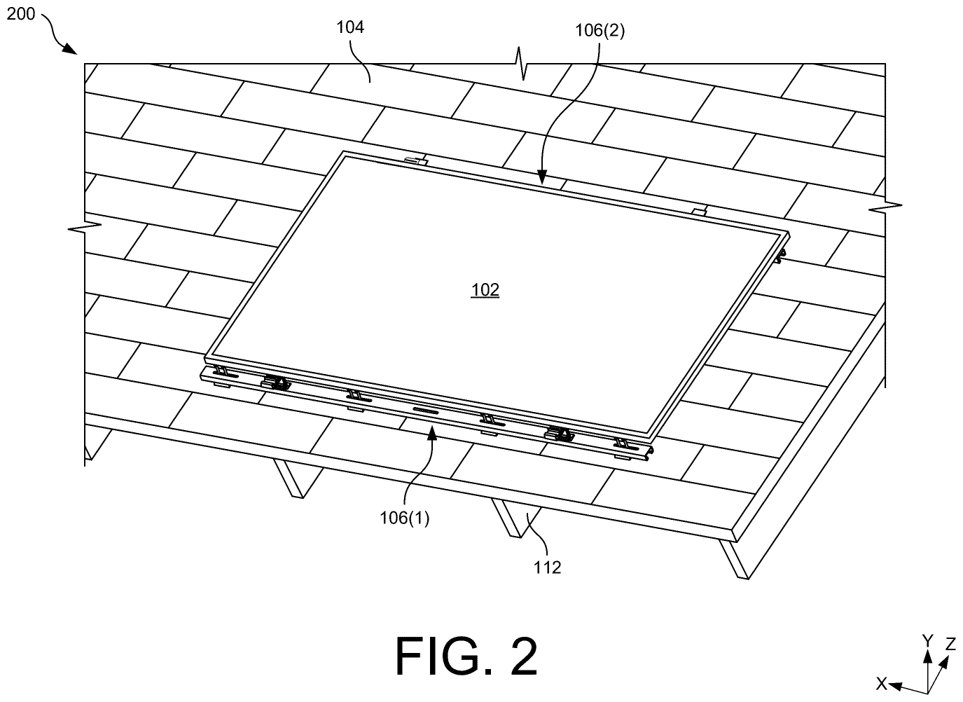

FIG. 2 illustrates an example environment 200 whereby a solar panel module 102 is attached to the roof 104, according to an embodiment of the present disclosure. The solar panel modules 102 may be attached to the roof 104 using two of the attachment apparatus 106, such as the attachment apparatus 106(1) and the attachment apparatus 106(2). Compared to FIG. 1, however, the attachment apparatuses 106 are shown arranged perpendicular to the rafters 112. For example, the rail of the attachment apparatuses 106 may be arranged perpendicular to the rafters 112. The rail may be disposed along a lengthwise direction of the solar panel module 102 whereby the solar panel modules 102 are arranged in landscape orientation on the roof 104. The fasteners that secure the attachment apparatus 106(1) and the attachment apparatus 106(2) to the roof 104 do not need to be secured into the rafters 112. Although FIG. 2 illustrates a single solar panel module 102 being secured to the roof 104, more than one solar panel module 102 may be secured to the roof 104, as discussed above with regard to FIG. 1.

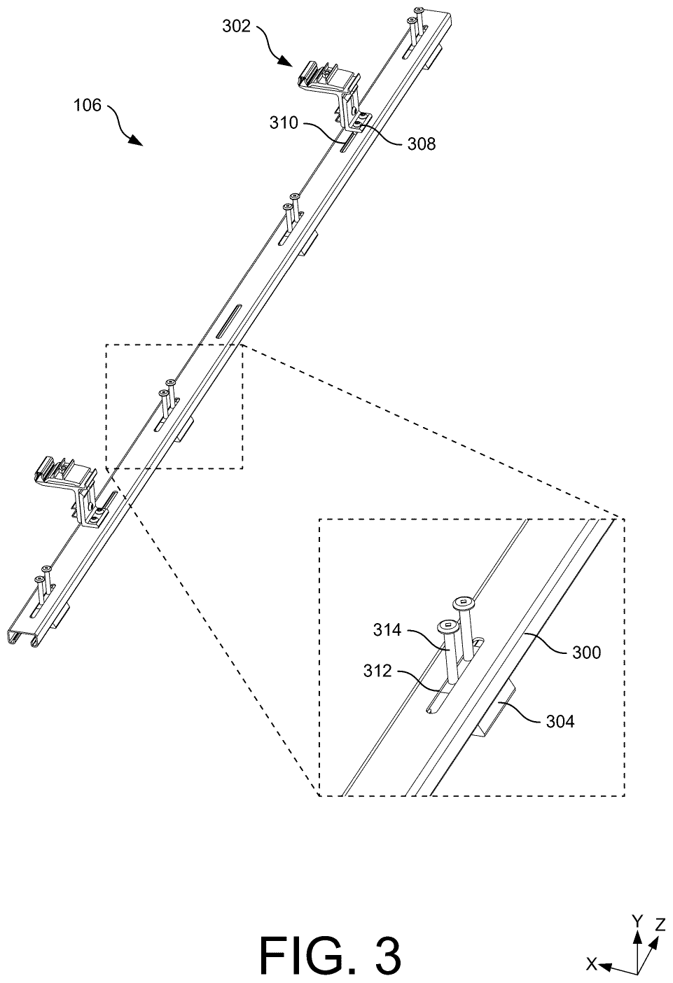

FIG. 3 illustrates the attachment apparatus 106, according to an embodiment of the present disclosure. The attachment apparatus 106 may include a rail 300, one or more clamps 302, and one or more bushings 304. The clamps 302 may secure to the rail 300 via one or more fasteners 308. The rail 300 may define first slots 310 through which the fasteners 308 are disposed. Prior to tightening the fasteners 308 to secure the clamps 302 to the rail 300, the fasteners 308 may be translated within the first slots 310. This may align the clamps 302 on a frame of the solar panel module 102, such as a return flange of the frame of the solar panel module 102. In an embodiment, two of the fasteners 308 may be used to secure the clamps 302 to the rail 300. Any number of the clamps 302 may be secured to the rail 300. That is, although the attachment apparatus 106 is shown including two of the clamps 302, more than or less than two of the clamps 302 may be secured to the rail 300 via the fasteners 308. In such instances, the rail 300 may include a corresponding number of first slots 310.

The clamps 302 are linearly-displaced along the length of the rail 300 to distribute loads from the solar panel modules 102. For example, loads (e.g., wind, snow, etc.) imparted to the clamps 302 may be distributed into and across the rail 300. The clamps 302 may be shaped and sized to be accommodated by the shape and/or profile of the rail 300. Although the clamps 302 are described as a separate component than the rail 300, in an embodiment, the clamps 302 may be integrated within the rail 300.

The rail 300 may also define second slots 312 in which fasteners 314 are disposed. The fasteners 314 may additionally be disposed through the bushings 304. As will be explained herein, the bushings 304 may be engaged within a channel of the rail 300 and translated along a length of the rail 300 to be disposed adjacent to the second slots 312, respectively. Once in position adjacent to the second slots 312, the fasteners 314 may be disposed through the second slots 312 and at least partially into the bushings 304. Prior to tightening the fasteners 314 to secure the attachment apparatus 106 to the roof 104, the fasteners 314 may be translated within the second slots 312. This may serve to space the bushings 304 apart from adjacent rows of shingles on the roof 104. For example, if the bushing 304 is disposed on a seam between two rows of shingles, such as teetering between two rows of shingles, a seal between the roof 104 and the bushing 304 may be compromised and result in leaks into the roof 104.

In an embodiment, two of the fasteners 314 may be used to secure the bushings 304 into the roof 104. The bushings 304 may include through holes into which the fasteners 314 are received. When the attachment apparatus 106 is secured to the roof 104, the rail 300 may not contact the roof 104. Instead, the bushings 304 may dispose the rail 300 above the roof 104 (e.g., in the Y-direction).

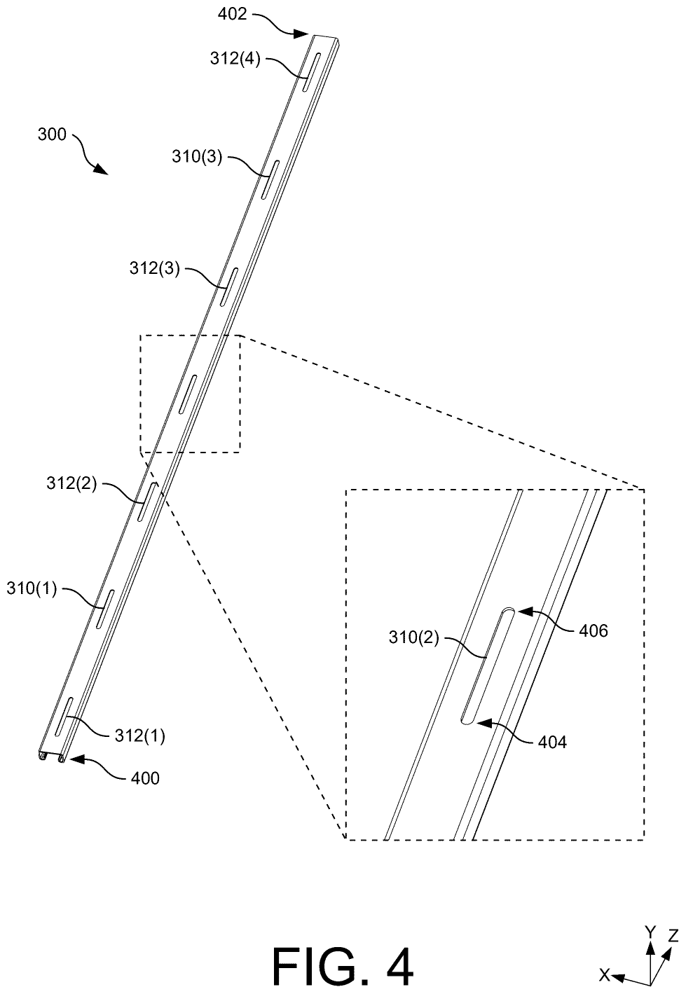

FIG. 4 illustrates an isometric view of the rail 300 of the attachment apparatus 106, according to an embodiment of the present disclosure. The rail 300 may include a first end 400 and a second end 402 spaced apart from the first end 400 (e.g., in the Z-direction). A length of the rail 300, or more generally, the attachment apparatus 106, may extend between the first end 400 and the second end 402. In an embodiment, the length of the rail 300 may be less than or greater than a dimension of the solar panel module 102. For example, the rail 300 may extend beyond an end or a periphery of the solar panel module 102. However, in embodiment, the rail 300 may include a length that is disposed within the ends of the periphery of the solar panel modules 102. Multiple rails 300 may also be adjoined together, end to end, for example, via one or more splices.

The rail 300 includes the first slots 310 and the second slots 312. In an embodiment, the first slots 310 and the second slots 312 may be alternatingly disposed between the first end 400 and the second end 402. For example, the rail 300 may include three of the first slots 310, such as a first slot 310(1), a first slot 310(2), and a first slot 310(3), and/or four of the second slots 312, such as second slot 312(1), a second slot 312(2), a second slot 312(3), and a second slot 312(4). In an embodiment, the rail 300 may include the same number of the first slots 310 as the second slots 312.

The first slots 310 may be associated with securing the clamps 302 to the rail 300. For example, as introduced above in FIG. 3, the fasteners 308 may be disposed through the first slots 310 and into the clamps 302. Given that the rail 300 has three of the first slots 310, the three of the clamps 302 may be secured to the rail 300. However, not all of the first slots 310 may be used to secure the clamps 302. For example, although the rail 300 has three of the first slots 310, only a subset of the first slots 310 may be used secure the clamps 302. The rail 300 may also include more than three of the first slots 310. In an embodiment, the number of first slots 310 may be based on specifics (e.g., size, weight, load rating, etc.) of the solar panel modules 102, the roof 104, etc.

The second slots 312 may be associated with securing the rail 300, or more generally, the attachment apparatus 106, to the roof 104. The fasteners 314 may be disposed through the second slots 312, through the bushings 304, and into the roof 104. The rail 300 is shown having four of the second slots 312. In such instances, the attachment apparatus 106 may have four attachment points, locations, etc., into the roof 104. However, not all of the second slots 312 may be used to secure the attachment apparatus 106 to the roof 104. Since the second slots 312 or the attachment points into the roof 104 are linearly displaced along the length of the rail 300, the elongation of the rail 300 allows for longitudinal distribution of the load to the roof 104 and thereby reduces the force of the load to the roof 104. The attachment points are distinct and separated from one another by a predetermined linear-displacement dimension along the length of the rail 300.

The first slots 310 and the second slots 312 may represent channels, passageways, slits, etc., formed in the rail 300. Additionally, although shown as slots, the fasteners 308 and/or the fasteners 314 may be disposed through holes in the rail 300. The first slots 310 and the second slots 312 may be similar or different, whether in length, shape, etc. For example, a detailed view of the first slots 310 is shown in FIG. 4 (e.g., the first slot 310(2)). The first slots 310 may include a first end 404 and a second end 406 spaced apart from the first end 404 (e.g., in the Z-direction). A width of the first slot 310 (e.g., in the X-direction) may accommodate the fasteners 308. The fasteners 308, when secured into the clamps 302, may be translatable between the first end 404 and the second end 406 to align the clamp 302 on the solar panel module 102. Although the detailed view is shown with regard to the first slots 310, the second slots 312 may be similar, and the fasteners 314 may similarly translate between ends of second slots 312 to space the bushings 304 from seams of shingles disposed on the roof 104.

The rail 300 may be a single, continuous extruded, stamped, roll-formed, etc., rail. The rail 300 may be formed of plastic, metal, or any suitable composite material or uniform material that is capable of sustaining loads experienced by the solar panel modules 102. Any suitable length of the rail 300 is envisioned to accommodate the solar panel modules 102.

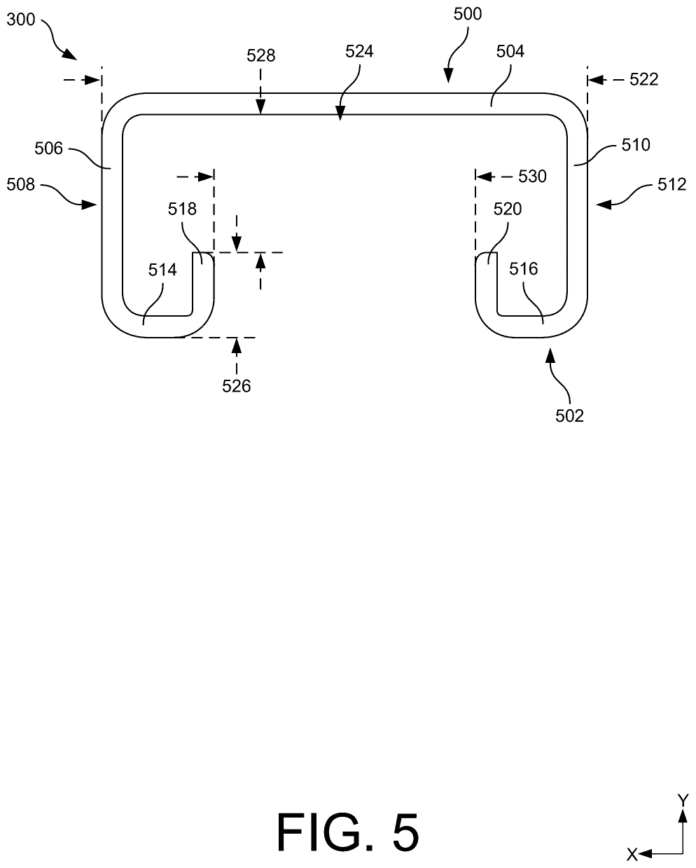

FIG. 5 illustrates an end view of the rail 300, such as the first end 400, according to an embodiment of the present disclosure. The rail 300 may include a top 500 and a bottom 502 spaced apart from the top 500 (e.g., in the Y-direction). The rail 300 may include a first sidewall 504 disposed along the top 500, a second sidewall 506 extending from the first sidewall 504 and disposed along a first side 508 of the rail 300, a third sidewall 510 extending from the first sidewall 504 and disposed along a second side 512 of the rail 300 (spaced apart from the first side 508 in the X-direction), a fourth sidewall 514 extending from the second sidewall 506 along the bottom 502, and a fifth sidewall 516 extending from the third sidewall 510 along the bottom 502. Moreover, the rail 300 may include a first flange 518 extending from the fourth sidewall 514 and a second flange 520 extending from the fifth sidewall 516. A width 522 of the rail 300 may be disposed between the first side 508 and the second side 512.

The rail 300 may include a channel 524 that at least partially receives the bushings 304 or within which the bushings 304 are at least partially disposed. In an embodiment, the channel 524 may be defined at least in part by the first sidewall 504, the second sidewall 506, the third sidewall 510, the fourth sidewall 514, the fifth sidewall 516, the first flange 518, and the second flange 520. The channel 524 may be open along the bottom 502 such that the fasteners 308 are insertable up through the channel 524 and into the clamps 302. Likewise, the open nature of the bottom 502 permits the bushings 304 to slide into engagement with the rail 300, and in a direction between the first end 400 and the second end 402 to align with the second slots 312.

As will be discussed herein, the fourth sidewall 514, the fifth sidewall 516, the first flange 518, and the second flange 520 may engage with features of the bushing 304. The engagement may secure the bushings 304 to the rail 300 to hold the bushings 304 in place during installation. A first dimension 526 may be disposed between the bottom 502 and an end of the first flange 518. The end of the second flange 520 may similarly be spaced apart from the bottom 502 by the first dimension 526. A second dimension 528 may be disposed between the end of the first flange 518 and/or the second flange 520, and the first sidewall 504. A third dimension 530 may be disposed between the first flange 518 and the second flange 520. These dimensions (i.e., the first dimension 526, the second dimension 528, and the third dimension 530) may engage with complimentary-sized features of the bushing 304.

Although a particular profile of the rail 300 is shown, other profiles are envisioned. For example, the sidewalls and/or flanges may be arranged or shaped differently than shown. In an embodiment, the profile of the rail 300 may be “U” shaped or “C” shaped. Additionally, the rail 300 may be enclosed on all sides, such as in the case of an elongated tube (e.g., along the bottom 502). The profile may be consistent along the length of the rail 300 or may vary for any reasons desired (e.g., strength, to save on material cost via thinning or openings, manufacturing feasibilities, custom configurations, etc.).

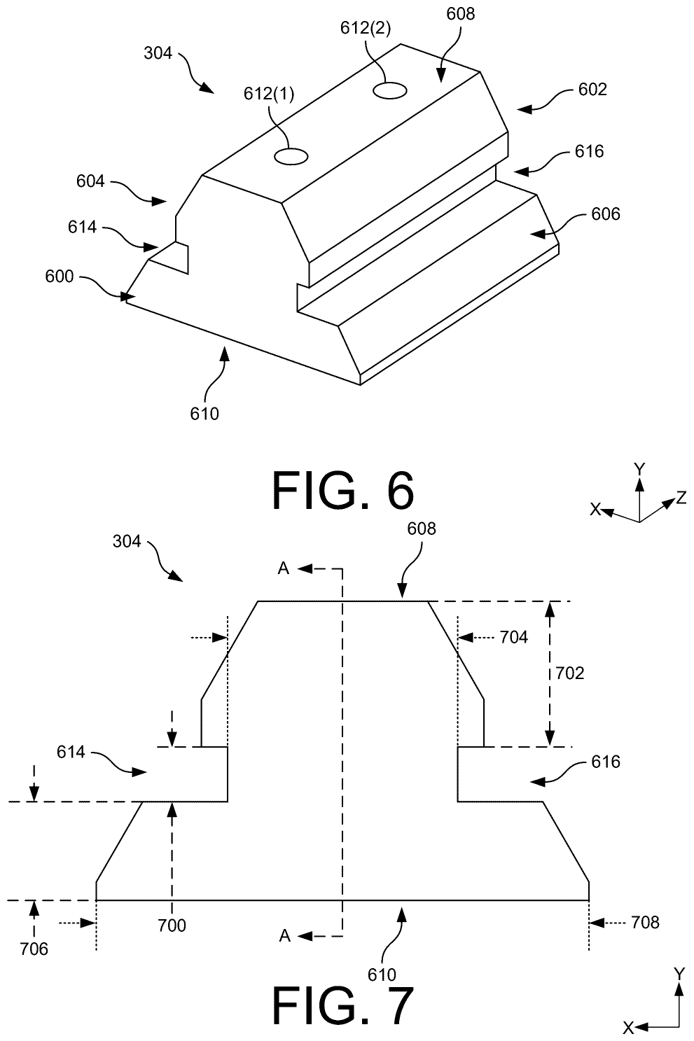

FIG. 6 illustrates an isometric view of the bushing 304, according to an embodiment of the present disclosure. The bushing 304 may include a first end 600, a second end 602 spaced apart from the first end 600 (e.g., in the Z-direction), a first side 604, a second side 606 spaced apart from the first side 604 (e.g., in the X-direction), a top 608, and a bottom 610 spaced apart from the top 608 (e.g., in the Y-direction). The bottom 610 may be disposed against the roof 104 when installed.

The bushing 304 includes through holes 612, such as a first through hole 612(1) and a second through hole 612(2). The through holes 612 may be disposed through the bushing 304, between the top 608 and the bottom 610. The bushing 304 may include a corresponding number of the through holes 612 as the fasteners 314. For example, in the event that two of the fasteners 314 secure the bushing 304 into the roof 104, the bushing 304 may include two of the through holes 612. The bushing 304, however, may include more than or less than two of the through holes 612. In an embodiment, the through holes 612 may be sized smaller than a width of the fasteners 314. The smaller diameter of the through holes 612 compared to the fasteners 314 may seal the fastener 314 against the bushing 304 to prevent an ingress of water into the through holes 612 and into the roof 104.

The bushing 304 includes a first notch 614 (e.g., indentation, groove, slit, etc.) disposed along the first side 604 and a second notch 616 (e.g., indentation, groove, slit, etc.) disposed along the second side 606. The first notch 614 may accommodate the fourth sidewall 514 and the first flange 518 for securing the bushing 304 to the rail 300. The second notch 616 may accommodate the fifth sidewall 516 and the second flange 520 for securing the bushing 304 to the rail 300. More generally, the first notch 614 and the second notch 616 may include any key/keyways, male/female connectors, etc., that mate with features of the rail 300. When secured to the rail 300, the top 608 of the bushing 304 may be disposed adjacent to the first sidewall 504, at a location within the channel 524, and the bottom 610 may be disposed external to the channel 524.

The bushing 304 may be manufactured suitable materials that assist in waterproofing penetrations into the roof 104. An example material includes rubber, silicone, butyl, etc. The bushing 304 may be at least partially deformable to compress against the roof 104 during tightening of the fasteners 314. This assists in sealing the bottom 610 of the bushing 304 against the roof 104. As will be explained herein, sealant may be at least partially disposed within the through holes 612. As the fasteners 314 are secured into the roof 104, the sealant may be drawn into the penetrations into the roof 104 to assist in waterproofing.

FIG. 7 illustrates an end view of the bushing 304, according to an embodiment of the present disclosure. The bushing 304 includes the first notch 614 located along or disposed in the first side 604 and the second notch 616 located along or disposed in the second side 606. The first notch 614 and the second notch 616 may engage with features of the rail 300. The first notch 614 and the second notch 616 may be similar to different compared to one another.

The first notch 614 and the second notch 616 may include a height 700 (e.g., in the Y-direction) that accommodates the first dimension 526. The top 608 of the bushing 304 may be spaced apart from the first notch 614 and the second notch 616 (e.g., in the Y-direction) by a dimension 702. The dimension 702 may be substantially similar to the second dimension 528, such that the top 608 of the bushing 304 is permitted to engage with the first sidewall 504 of the rail 300. Moreover, a dimension 704 may extend between surfaces or sidewalls of the first notch 614 and the second notch 616 to engage with the first flange 518 and the second flange 520, respectively. Although a particular shape and/or size of the first notch 614 and the second notch 616 are shown, other variations are envisioned.

The bottom 610 of the bushing 304 may be spaced apart from the first notch 614 and the second notch 616 by a dimension 706. The dimension 706 may space the rail 300 apart from the roof 104, such that upon installation, the rail 300 does not contact the roof 104 (i.e., is spaced above or offset from the roof 104). The bushing 304 may also include a width 708 (e.g., in the X-direction) disposed along the bottom 610. The width 708 may be greater than the width 522 of the rail 300.

Although a single bushing is shown for the fasteners 314, each of the fasteners 314 may be disposed through their own bushing. For example, a first of the fasteners 314 may be disposed through a first bushing and a second of the fasteners 314 may be disposed through a second bushing. The separate bushings may seal around the fasteners 314.

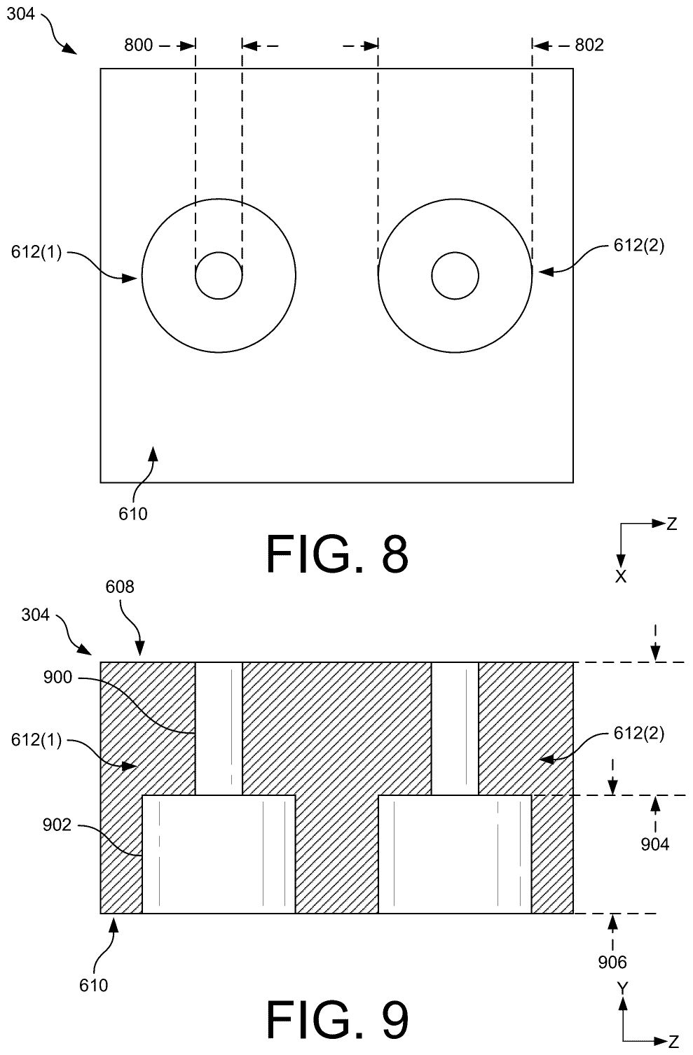

FIG. 8 illustrates the bottom 610 of the bushing 304, according to an embodiment of the present disclosure. The through holes 612 may extend through a thickness of the bushing 304 (e.g., in the Y-direction). As shown, the through holes 612 may be circular in shape, however, other shapes are envisioned.

In an embodiment, the through holes 612 may include different cross-sectional dimensions. For example, the through holes 612 may include a first cross-sectional dimension 800 disposed at or extending from the top 608. The through holes 612 may include a second cross-sectional dimension 802 disposed at or extending from the bottom 610. The first cross-sectional dimension 800 may be smaller than the second cross-sectional dimension 802. Introduced above, the first cross-sectional dimension 800 may be sized smaller than a width of the fasteners 314 such that the fasteners 314 are sealed within the through holes 612. The second cross-sectional dimension 802 may accommodate a sealant disposed within the through holes 612. The sealant may be injected or otherwise disposed in a portion of the bushing 304 corresponding to the second cross-sectional dimension 802. In an embodiment, the sealant may be disposed at a time of manufacturing, before installation onto the roof 104, etc. The sealant may be a flowable sealant, a liquid sealant, an injectable sealant, or an adhesive sealant. An example sealant includes butyl.

FIG. 9 illustrates a cross-sectional view of the bushing 304 taken along line A-A of FIG. 7, according to an embodiment of the present disclosure. The through holes 612 may include a first portion 900 having the first cross-sectional dimension 800 and a second portion 902 having the second cross-sectional dimension 802. The first portion 900 is disposed from the top 608 to engage the fasteners 314, while the second portion 902 is disposed from the bottom 610 to receive the sealant. In an embodiment, a film, release strip, etc., may be disposed along the bottom 610 to prevent inadvertent adhesion of debris, packaging, dust, etc., with the sealant (e.g., in the case where the sealant is pre-applied).

The first portion 900 may include a first length 904 (e.g., in the Y-direction) and the second portion 902 may include a second length 906 (e.g., in the Y-direction). The first length 904 may be greater than the second length 906. However, in an embodiment, the first length 904 and the second length 906 may be the same, and/or the second length 906 may be greater than the first length 904.

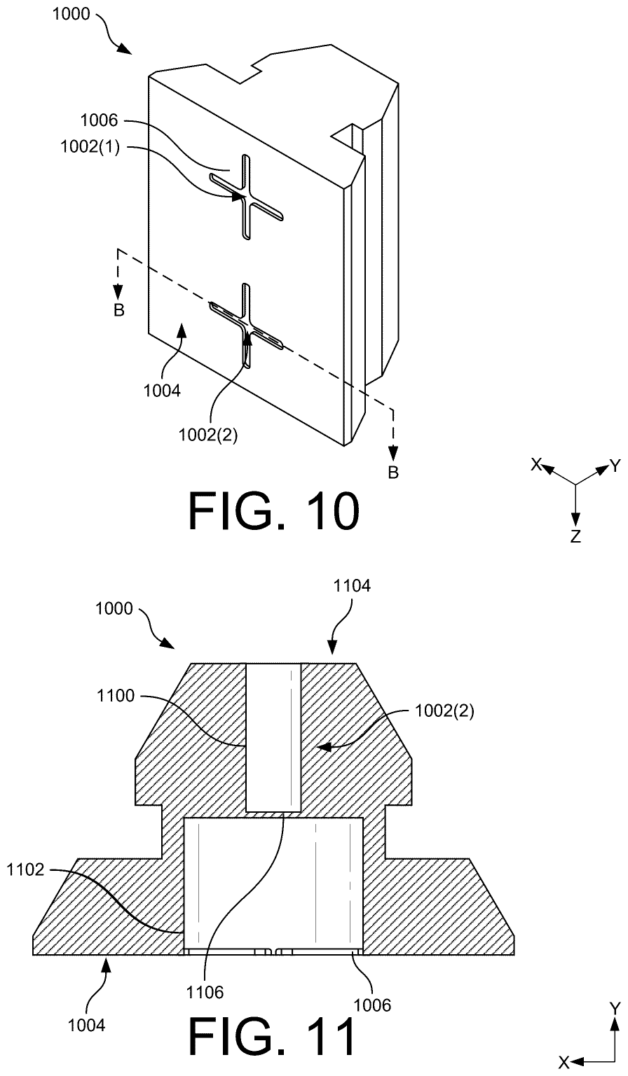

FIG. 10 illustrates an example bushing 1000, according to an embodiment of the present disclosure. The bushing 1000 may be similar to the bushing 304 as discussed above. The bushing 1000 may be used in lieu of the bushing 304 and/or in addition to the bushing 304.

Compared to the bushing 304, the bushing 1000 may have through holes 1002, such as a first through hole 1002(1) and a second through hole 1002(2), that are at least partially enclosed. The partially enclosed nature of the through holes 1002 may avoid debris, packaging, dust, etc., adhering to the sealant disposed within the through holes 1002 prior to installation onto the roof 104. For example, along a bottom 1004 of the bushing 1000, the through holes 1002 may be at least partially enclosed via one or more flaps 1006. The flaps 1006 may be a component of the bushing 1000 or otherwise integrated within the bushing 1000. As shown, each of the through holes 1002 may be partially enclosed via four of the flaps 1006 along the bottom 1004. During tightening of the fastener 314 into the roof 104, the fastener 314 may be disposed between or extend through a space between the flaps 1006. In an embodiment, the flaps 1006 may not be adjoined to one another along one or more sides.

In an embodiment, through holes 1002 may be enclosed along the bottom 1004. For example, a thinned membrane or wall, similar to the flaps 1006 may enclose the through holes 1002. The enclosed nature of the through holes 1002 may prevent inadvertent adhesion with the sealant and/or help retain the sealant within the through holes 1002. During securement to the surface, the fasteners 314 may pierce through the thinned membrane or wall and into the surface.

FIG. 11 illustrates a cross-section of the bushing 1000, taken along line B-B of FIG. 10, according to an embodiment of the present disclosure. The through holes 1002 may include a first portion 1100 (e.g., compartment, section, etc.) and a second portion 1102 (e.g., compartment, section, etc.). The first portion 1100 may extend from a top 1104 of the bushing 1000. The second portion 1102 may extend from the bottom 1004 of the bushing 1000. The first portion 1100 may be similar to the first portion 900 of the bushing 304, and/or the second portion 1102 may be similar to the second portion 902 of the bushing 304. For example, the first portion 1100 may include a smaller cross-sectional dimension (e.g., in the X-direction) than the second portion 1102. In an embodiment, a segment 1106 of the bushing 1000 may be disposed between the first portion 1100 and the second portion 1102. The segment 1106 may represent a thinned section of the bushing 1000 that is pierced by the fastener 314 when disposed into the roof 104.

The second portion 1102 may be at least partially filled with the sealant. In an embodiment, a nozzle may be inserted through the flaps 1006 to inject or dispose the sealant into the second portion 1102. The flaps 1006 and the segment 1106 may prevent inadvertent adhesion with the sealant prior to installation. The flaps 1006 may also assist in retaining the sealant within the second portion 1102. However, the sealant may grip or otherwise adhere to the fastener 314 as the fastener 314 passes through the second portion 1102 and into the roof 104. In doing so, the sealant may be drawn into the roof 104 to seal around a hole created by the fastener 314.

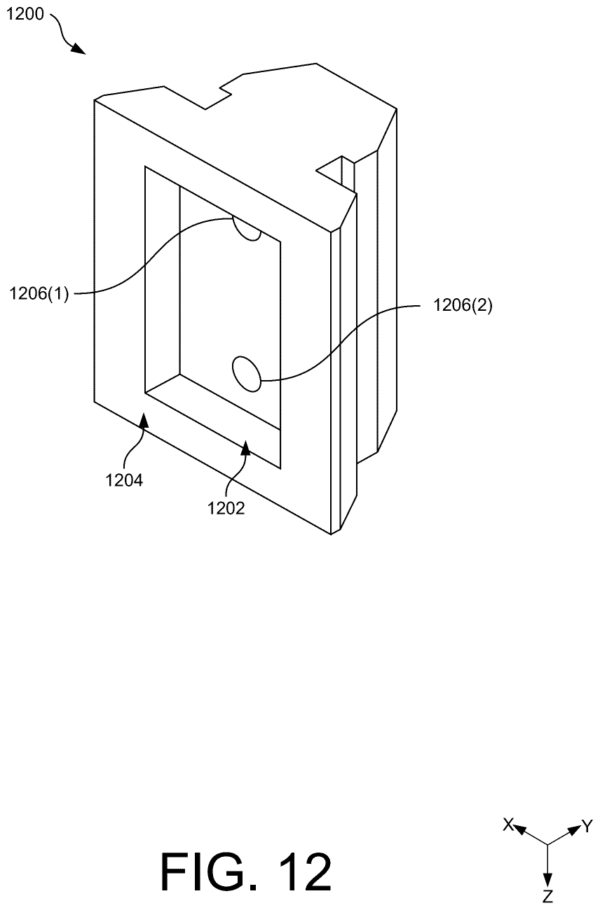

FIG. 12 illustrates an example bushing 1200, according to an embodiment of the present disclosure. The bushing 1200 may be similar to the bushing 304 and/or the bushing 1000 as discussed above. In an embodiment, the bushing 1200 may be used in lieu of the bushing 304 and/or the bushing 1000, and/or in addition to the bushing 304 or the bushing 1000.

Compared to bushing 304 and the bushing 1000, the bushing 1200 is shown including a cavity 1202 disposed along a bottom 1204. The cavity 1202 may be connected to through holes 1206, such as a first through hole 1206(1) and a second through hole 1206(2). That is, compared to the bushing 304 and/or the bushing 1000 in which the through holes 612 and the through holes 1002 are not adjoined, respectively, the through holes 1206 may be at least partially adjoined over their length via the cavity 1202. The cavity 1202 may be filled with the sealant during or prior to installation. In an embodiment, the cavity 1202 may be rectangular shaped, however, other shapes are envisioned.

In an embodiment, a film or membrane may be disposed along the bottom 1204 to prevent inadvertent adhesion with the sealant. The membrane may be removed prior to installation of the bushing 1200 onto the roof 104.

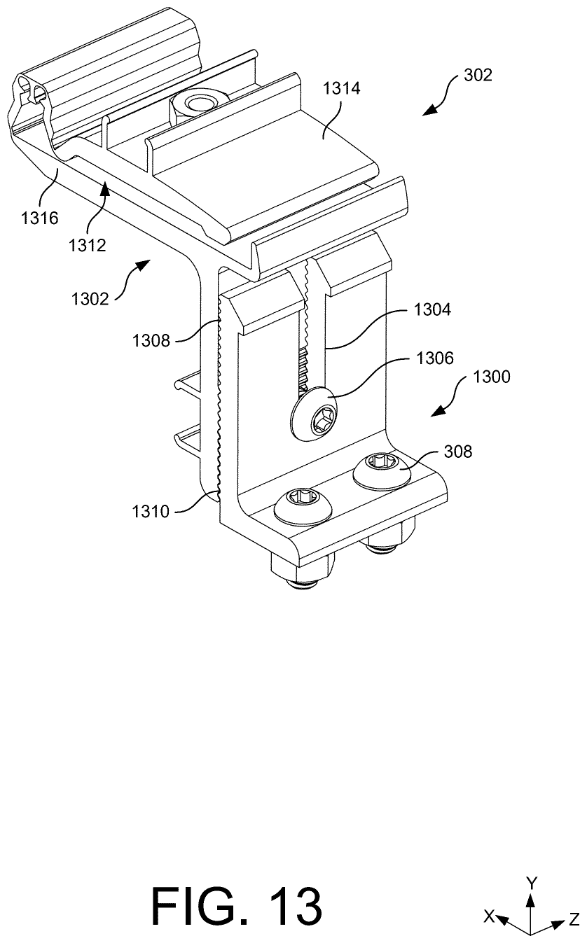

FIG. 13 illustrates an isometric view of the clamp 302, according to an embodiment of the present disclosure. The clamp 302 may include a bracket 1300 and a stanchion 1302 attached to the bracket 1300. The bracket 1300 may receive the fasteners 308 that secure the clamp 302 to the rail 300. For example, the fasteners 308 may be disposed through the first slots 310 and into holes, channels, passages, etc., formed in the bracket 1300. In an embodiment, the holes may be threaded or nuts may be used to secure the bracket 1300 to the rail 300. As indicated above, prior to tightening the fasteners 308, the fasteners 308 may be translated within the first slots 310 to position the clamp 302 on the solar panel module 102. In an embodiment, the fasteners 308 may be tightened to temporarily secure the clamps 302 to the rail 300, and then once the clamps 302 are secured to the rail 300, the fasteners 308 may be fully tightened or actuated.

The bracket 1300 may include a channel 1304 though which a fastener 1306 is disposed for securing the stanchion 1302 to the bracket 1300. The fastener 1306 may be disposed at various positions within the channel 1304 for adjusting a height of the stanchion 1302 above the roof 104. The bracket 1300 may include teeth 1308 that interlock, engage, mate, etc., with teeth 1310 on the stanchion 1302. As the stanchion 1302 is raised to various positions, the teeth 1308 and the teeth 1310 may engage to secure the stanchion 1302 in place during tightening of the fastener 1306.

The stanchion 1302 may define a receptacle 1312 that receives a portion of the solar panel module. For example, a frame of the solar panel module 102 may be disposed at least partially within the receptacle 1312. In an embodiment, the receptacle 1312 may be defined at least in part by an arm 1314 and a platform 1316. As will be explained herein, a fastener may be tightened to secure the solar panel module 102 within the receptacle 1312. For example, as the fastener is tightened, the arm 1314 may be urged in a direction towards the platform 1316 to clamp the frame of the solar panel module 102 between the arm 1314 and the platform 1316. The arm 1314 and the platform 1316 may be adjoined to reduce installation complexities and/or a need to hold the arm 1314 during tighten of the fastener to secure the solar panel module within the receptacle 1312.

The clamp 302 may be formed of plastic, metal, or any suitable composite material or uniform material. The clamp 302 may be manufactured via extrusion, stamping, bending process, and/or one or more post-processing techniques (e.g., milling, machining, etc.). Although the clamp 302 is shown including certain components, the clamp 302 may include different components and/or a greater number of components than shown.

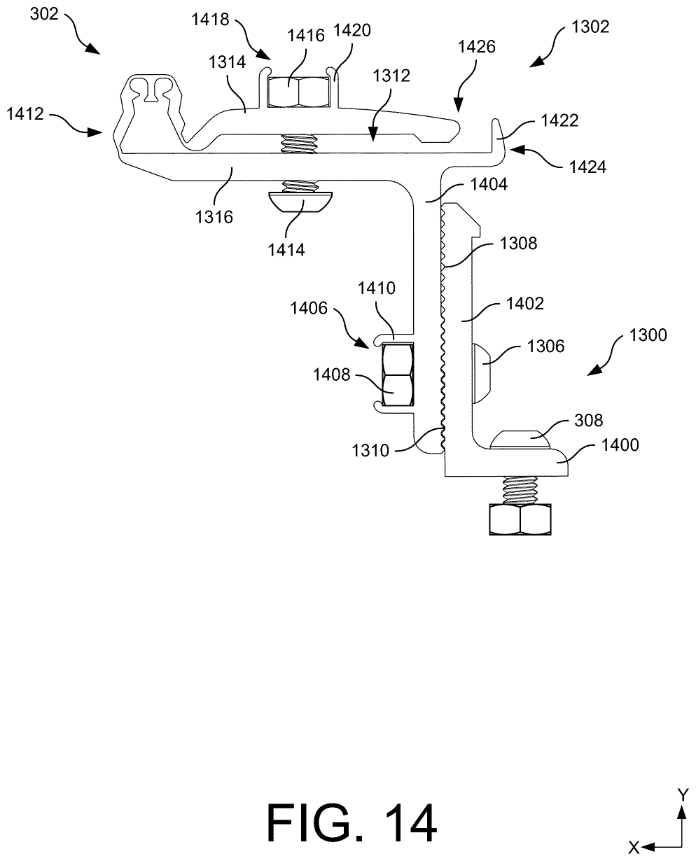

FIG. 14 illustrates a side view of the clamp 302, according to an embodiment of the present disclosure. As introduced above, the clamp 302 includes the bracket 1300 and the stanchion 1302. The bracket 1300 may include a base 1400 through or into which the fasteners 308 are disposed. The bracket 1300 may also include a vertical body 1402 (e.g., arm, leg, strut, etc.) that extends from the base 1400. The vertical body 1402 may be disposed orthogonally relative to the base 1400. The vertical body 1402 may include the teeth 1308 and define the channel 1304. The base 1400 may be a monolithic component or unitary body.

The stanchion 1302 includes the arm 1314, the platform 1316, and a vertical body 1404 (e.g., leg, strut, etc.). The vertical body 1404 includes the teeth 1310 that mate with the teeth 1308 of the vertical body 1402. The vertical body 1404 also includes a receptacle 1406 that receives a nut 1408 into which the fastener 1306 is disposed. The receptacle 1406 may be defined by one or more arms 1410 that extend from the vertical body 1404. An engagement between the nut 1408 and the one or more arms 1410 prevents a rotation of the nut 1408 during tightening of the fastener 1306.

As indicated previously, the stanchion 1302 may be raised to various positions relative to the bracket 1300, during which the fastener 1306 translates within the channel 1304. The stanchion 1302 may therefore telescope from the bracket 1300. Once a desired height is achieved, the fastener 1306 may be tightened into the nut 1408, thereby engaging the teeth 1308 and the teeth 1310, and securing the stanchion 1302 in place along the vertical body 1402.

The arm 1314 extends from the platform 1316 at a first end 1412 of the platform 1316. In an embodiment, the arm 1314 may pivotably secure to the platform 1316 at the first end 1412. The arm 1314 and the platform 1316 may therefore be connected to one another. The pivotable nature of the arm 1314 relative to the platform 1316 permits an insertion of the frame of the solar panel module 102 within the receptacle 1312. For example, the arm 1314 may be urged in a direction away from the platform 1316 (e.g., pivoting about the first end 1412) to open the receptacle 1312 and allow for an insertion of the frame of the solar panel module 102 into the receptacle 1312. However, in an embodiment, the arm 1314 and the platform 1316 may be separate components that are connected together. In addition, although a specific shape, profile, contour, etc., of an engagement between the arm 1314 and the platform 1316 is shown, other variations are envisioned.

A fastener 1414 is shown securing the arm 1314 and the platform 1316 together. The fastener 1414 may be threaded into a nut 1416 disposed within a receptacle 1418 of the arm 1314. The receptacle 1418 may be defined by one or more arms 1420 that extend from the arm 1314. An engagement between the nut 1416 and the one or more arms 1420 prevents a rotation of the nut 1416 during tightening of the fastener 1414. For example, after insertion of the solar panel module 102 into the receptacle 1312, the fastener 1414 may be tightened. During this tightening, the frame of the solar panel module 102 becomes clamped between the arm 1314 and the platform 1316. In other words, the arm 1314 is urged towards the platform 1316 during tightening of the fastener 1414. Moreover, given an attachment between the arm 1314 and the platform 1316, an installer may not have to hold the arm 1314 during tightening of the fastener 1414 to prevent rotation of the arm 1314 (e.g., via motion imparted to the arm 1314 via the fastener 1414).

The vertical body 1404 may extend from the platform 1316. In an embodiment, the vertical body 1404 extends orthogonally from the platform 1316. The platform 1316 may also include a lip 1422 disposed at a second end 1424 of the platform 1316, spaced apart from the first end 1412 (e.g., in the X-direction). The lip 1422 may extend transversely from the platform 1316. A frame of the solar panel module 102 may abut against the lip 1422 to seat or otherwise orient the solar panel module 102 within the receptacle 1312. As shown, an end 1426 of the arm 1314 may be spaced apart from the lip 1422 to permit insertion of the solar panel module 102 into the receptacle 1312.

Although the fastener 1306 and the fastener 1414 are described as threading into the nut 1408 and the nut 1416, respectively, in an embodiment, the fastener 1306 and the fastener 1414 may thread directly into the vertical body 1404 and the arm 1314 (e.g., via a threaded aperture), respectively.

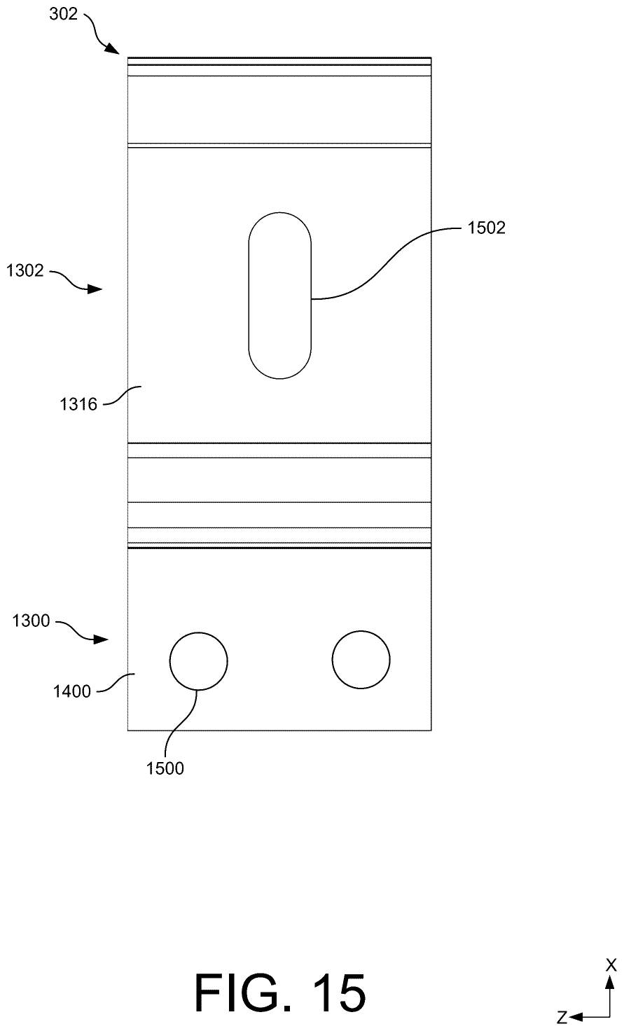

FIG. 15 illustrates a bottom view of the clamp 302, according to an embodiment of the present disclosure. The base 1400 of the bracket 1300 defines apertures 1500 through which the fasteners 308 are disposed, respectively. The apertures 1500 may be threaded apertures into which the fasteners 308 are secured, or may be through holes, whereby the fasteners 308 may thread into a corresponding nut. The platform 1316 may also define a channel 1502 through which the fastener 1414 is disposed. The fastener 1414 may be translated within the channel 1502 to position the solar panel module 102 within the receptacle 1312, or permit flexibility of the arm 1314 during positioning of the solar panel module 102 within the receptacle 1312.

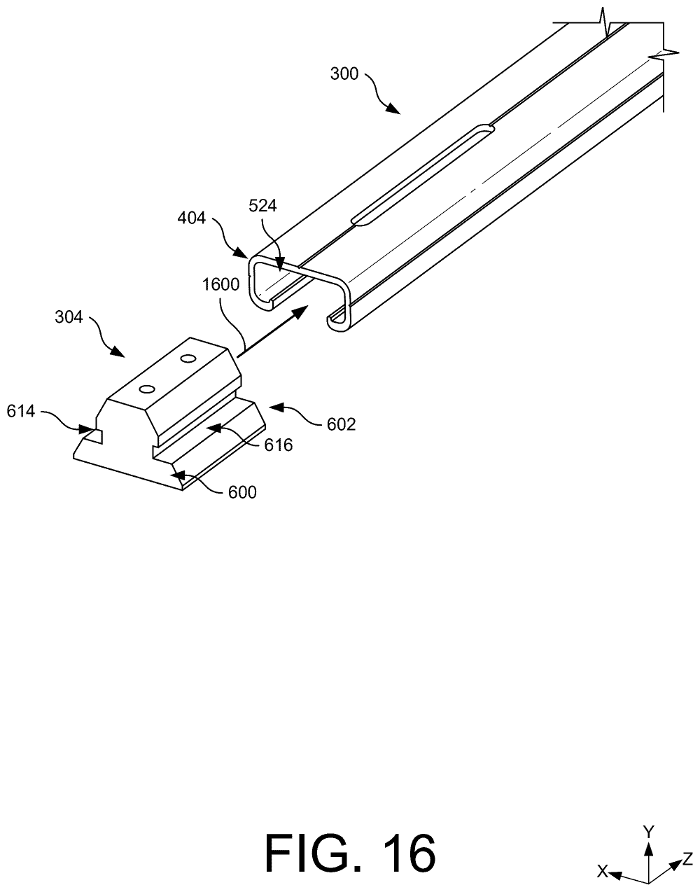

FIG. 16 illustrates an example insertion of the bushing 304 into the channel 524 of the rail 300, according to an embodiment of the present disclosure. Although the discussion is with regard to the bushing 304, the bushing 1000 and/or the bushing 1200 may similarly be inserted into the channel 524.

The second end 602 of the bushing 304 may be inserted into the first end 404 of the rail 300 in a direction 1600. However, the second end 602 may similarly be inserted into the second end 406, and/or the first end 600 may be inserted into the first end 404 and/or the second end 406. During an insertion, the first notch 614 and the second notch 616 engage with the features of the rail 300, such as the fourth sidewall 514, the fifth sidewall 516, the first flange 518, and the second flange 520, respectively. This engagement secures the bushing 304 to the rail 300, or within the channel 524. However, upon application of a sufficient amount of force, the bushing 304 may be translated within the rail 300 to align the through holes 612 with the second slots 312 to permit the fasteners 314 to be disposed into the roof 104.

Although a particular engagement between the rail 300 and the bushing 304 is described, other variations are envisioned. For example, the rail 300 may not include the channel 524, but may present a tubular rail. In such instances, a circular bushing with a through hole and/or cavity to receive the sealant may be disposed between the rail 300 and the roof 104. Moreover, the bushing 304 and/or the rail 300 may include different features that engage with one another.

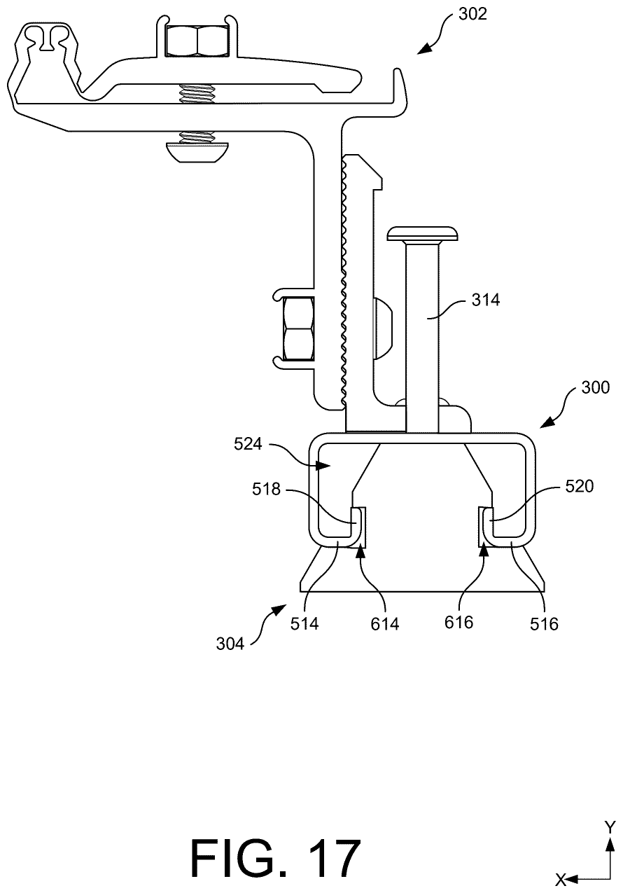

FIG. 17 illustrates an engagement between the clamp 302 and the rail 300, and the bushing 304 and the rail 300, according to an embodiment of the present disclosure. Introduced above in FIG. 16, the bushing 304 may be inserted into the channel 524. The bushing 304 may be slid within the channel 524 to align the through holes 612 with the second slots 312. Therein, the fasteners 314 may be disposed at least partially into, or through, the through holes 612. Given that more than one bushing 304 may be disposed within the channel 524, the fasteners 314 may not be inserted into the through holes 612 to prevent additional bushings 304 being inserted into and slide through the channel 524. For example, disposing the fasteners 314 through the second slots 312 and into the bushing 304 may prevent additional bushings being inserted into the channel 524, given that the fasteners 314 will abut ends of the second slot 312 and prevent the bushing 304 from sliding further into the channel 524. In an embodiment, the bushings 304 may be positioned adjacent to the second slot 312(2) and/or the second slot 312(3) first, before the second slot 312(1) and/or the second slot 312(4).

The bushing 304 is shown engaging with the rail 300, which may prevent a repositioning and/or reorientation of the bushing 304. For example, the fourth sidewall 514 and the first flange 518 are shown at least partially engaging with the first notch 614 and the fifth sidewall 516 and the second flange 520 are shown at least partially engaging with the second notch 616. This engagement is accomplished via the dimensions of the sidewalls, flanges, and notches, as discussed above.

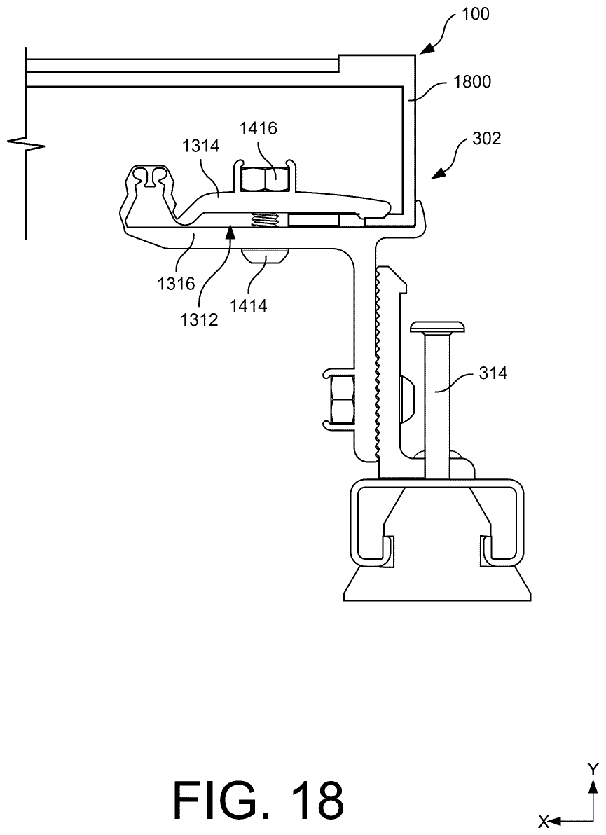

FIG. 18 illustrates an example engagement between the solar panel module 102 and the clamp 302, or more generally, the attachment apparatus 106 to the solar panel module, according to an embodiment of the present disclosure. A frame 1800 of the solar panel module 102 may be disposed at least partially in the receptacle 1312, between the arm 1314 and the platform 1316. Once inserted, the fastener 1414 may be tightened into the nut 1416 to clamp the rail 300 within the receptacle 1312. An engagement between the nut 1416 and the one or more arms 1420 prevents rotation of the nut 1416 during tightening of the fastener 1414. Alternatively, in an embodiment, the arm 1314 may include a threaded receptacle into which the fastener 1414 is threaded. This may eliminate the use of the nut 1416.

In an embodiment, the solar panel module 102 may initially be clamped to the attachment apparatus 106, prior to installation of the attachment apparatus 106 onto the roof 104. For example, the frame 1800 of the solar panel module 102 may be secured within the receptacle 1312 via tightening of the fastener 1414. As an assembly, the attachment apparatus 106 and the solar panel module 102 may be positioned on the roof 104. Therein, the fasteners 314 may be fastened into the roof 104 to secure the attachment apparatus 106 and the solar panel module 102 to the roof 104. Pre-installing the attachment apparatus 106 to the solar panel module 102 may reduce installation times and/or an amount of time installers may to be on the roof 104.

The solar panel module 102, such as an end thereof, may not impede securing the fasteners 314 into the roof 104. A tool may easily access the fasteners 314 and allow an installer to easily secure the attachment apparatus 106 to the roof 104. While it is contemplated that the overlap between the solar panel module 102 and the rail 300 may be greater than shown, it is considered that additional overlap may create additional difficulty and/or time to install the attachment apparatus 106. As such, it is contemplated that the rail 300 be installed at a position where the end edge of the solar panel module 102 does not vertically overlap the rail 300 to inhibit access to the fasteners 314.

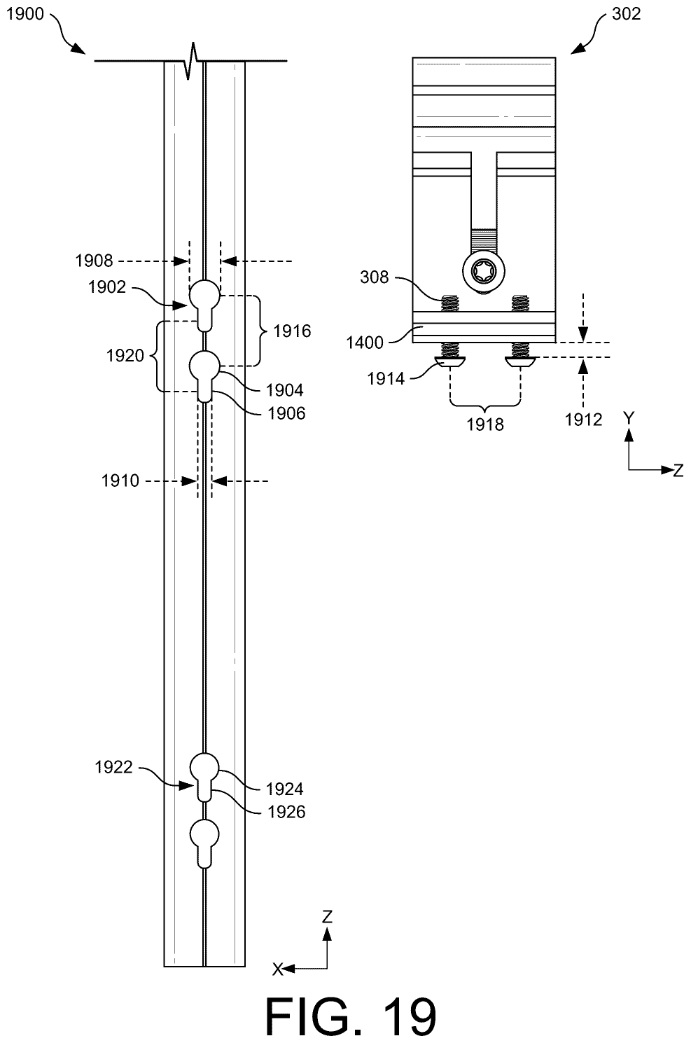

FIG. 19 illustrates an example rail 1900 that may be usable with the attachment apparatus 106, according to an embodiment of the present disclosure. In an embodiment, the rail 1900 may be used in lieu of, or in addition to, the rail 300.

The rail 1900 may be similar to the rail 300, however, the rail 1900 may include differently shaped slots for accommodating the fasteners 308 and the fasteners 314, respectively. The rail 1900 may include first slots 1902 for accommodating the fasteners 308 used to secure the clamp 302 to the rail 1900. The first slots 1902 may include two separate slots, where each of the first slots 1902 have differently sized portions, segments, sections, etc. For example, the first slots 1902 may include a first section 1904 and a second section 1906 that are adjoined or connected. The first section 1904 may be circular in shape to accommodate a head of the fasteners 308. The first section 1904 may also include a first dimension 1908 that is greater than a second dimension 1910 of the second section 1906 (e.g., in the X-direction).

In an embodiment, the fasteners 308 may be pre-installed into the clamp 302, such as the base 1400 of the bracket 1300, although the fasteners 308 may not be fully tightened. For example, a gap distance 1912 may be disposed between a head 1914 of the fasteners 308 and the base 1400. The gap distance 1912 may be greater than a thickness of the sidewalls (e.g., a first sidewall) of the rail 1900. With the fasteners 308 pre-installed into the clamp 302, the fasteners 308 may be disposed through the first section 1904 of the first slots 1902. A width of the head 1914 of the fastener 308 may be less than the first dimension 1908 such that the head 1914 is insertable into the first slots 1902. With the heads 1914 inserted into the first section 1904, the clamp 302 may be urged in a direction to dispose the fasteners 308 within the second section 1906. Given that the width of the head 1914 is greater than the second dimension 1910, the fasteners 308 are prevented from being pulled out of, or disengaged with, the first slots 310, respectively (e.g., in the Y-direction). The fasteners 308 may be tightened once the fasteners 308 are disposed in the second section 1906 to secure the clamp 302 to the rail 1900.

A first distance 1916 may be disposed between a center of the first section 1904 of the first slot 1902 and a center of the second section 1906 of the first slot 1902. The first distance 1916 may accommodate a distance 1918 disposed between the heads 1914 of the fasteners 308 to permit the fasteners 308 to be inserted into the first slots 310, respectively. A second distance 1920 may be disposed between a center of the second section 1906 of the first slot 1902 and a center of the second section 1906 of the first slot 1902. The second distance 1928 may be the same as the first distance 1916. In an embodiment, the fasteners 308 may translate from the first section 1904 to the second section 1906 by the second distance 1918.

The rail 1900 may include second slots 1922 that are similar to the first slots 1902. Here, the fasteners 308 may be disposed at least partially within the through holes 612 of the bushings 304. Therein, the fasteners 314 may be disposed up through the second slots 1922, respectively (e.g., from the bottom of the rail 1900 and into a first section 1924 of the second slots 1922). The fasteners 314 may then be translated to a second section 1926 of the second slots 1922. After transporting to the roof 104, the fasteners 314 may secure the rail 1900 to the roof 104. The rail 1900 may include any number of the first slots 1902 and the second slots 1922. The rail 1900 may also be interconnected to other rails via one or more splices.

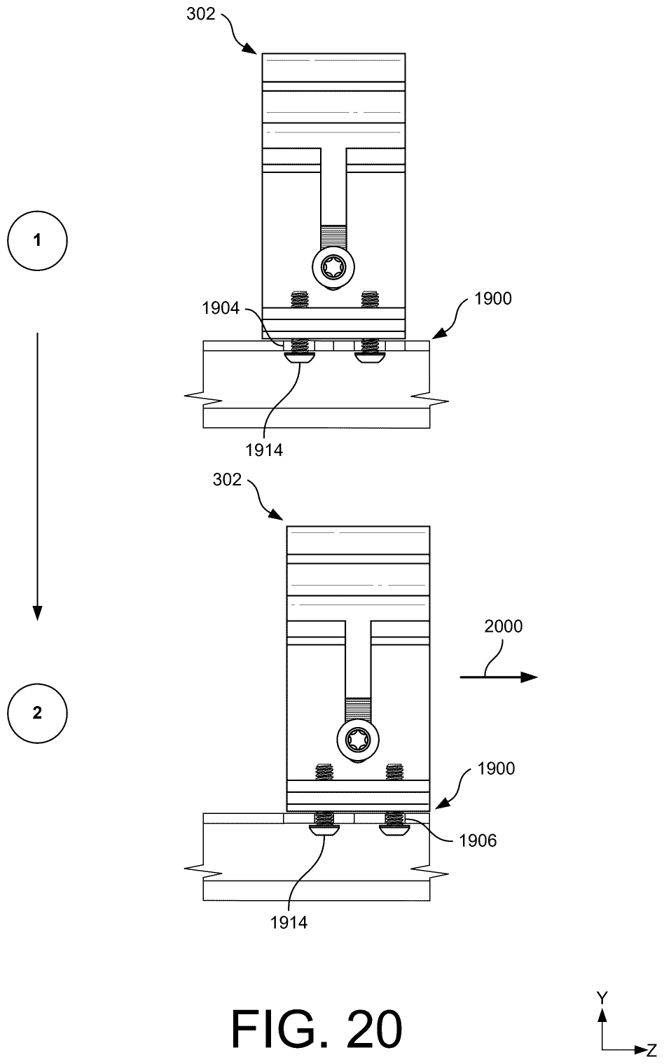

FIG. 20 illustrates an example sequence for attaching the clamps 302 to the rail 1900, according to an embodiment of the present disclosure. At “1” in FIG. 20, the head 1914 of the fasteners 308 may be disposed through the first section 1904 of the first slots 1902. The first dimension 1908 of the first section 1904 accommodates the width of the heads 1914. With the fasteners 308 disposed at least partially through the first slots 310, at “2” the clamp 302 may be translated in a direction 2000. The direction 2000 may be towards the second section 1906 such that the fasteners 308 are disposed within the second section 1906 of the first slots 1902. With the heads 1914 disposed adjacent to the second section 1906, given the smaller dimension of the heads 1914 relative to the second section 1906, the heads 1914 are prevented from being pulled through the first slots 1902, respectively. The fasteners 308 may therein be tightened to secure the clamps 302 to the rail 1900.

Although the discussion of FIG. 20 is with regard to the clamps 302 and the rail 1900, the fasteners 314 may similarly be disposed through the second slots 1922 and translate with the sections of the second slots 1922 during an attachment of the bushings 304 to the rail 1900 and into the roof 104.

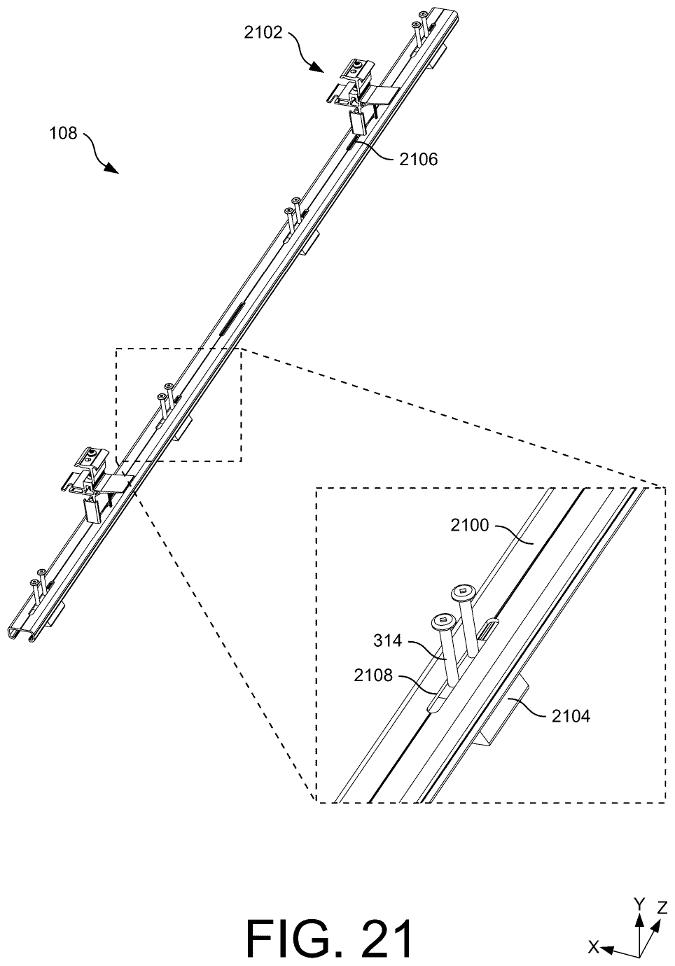

FIG. 21 illustrates the attachment apparatus 108, according to an embodiment of the present disclosure. The attachment apparatus 108 may include a rail 2100, one or more clamps 2102, and one or more bushings 2104.

The clamps 2102 may secure to the rail 2100 via the fasteners 308. The rail 2100 may define first slots 2106 through which the fasteners 308 are disposed. Prior to tightening the fasteners 308 to secure the clamps 2102 to the rail 2100, the fasteners 308 may be translated within the first slots 2106. In an embodiment, two of the fasteners 308 may be used to secure the clamps 2102 to the rail 2100. Any number of the clamps 2102 may be secured to the rail 2100. The clamps 2102 are shown being linearly-displaced along the length of the rail 2100 to distribute loads from the solar panel modules 102 across the rail 2100 and into the roof 104.

The rail 2100 may also define second slots 2108 in which fasteners 314 are disposed. The fasteners 314 may additionally be disposed at least partially through the bushings 2104 to secure the bushings 2104 to the rail 2100. The bushings 2104 may be similar to the bushings 304. Alternatively, in an embodiment, the bushings 1000 and/or the bushings 1200 may be used with the attachment apparatus 108. The fasteners 314 may be disposed through the second slots 2108 and into the bushings 2104. Prior to tightening the fasteners 314 to secure the attachment apparatus 108 to the roof 104, the fasteners 314 may be translated within the second slots 2108. In other respects, the rail 2100 may be similar to the rail 300. Additionally or alternatively, the attachment apparatus 108 may use the rail 1900.

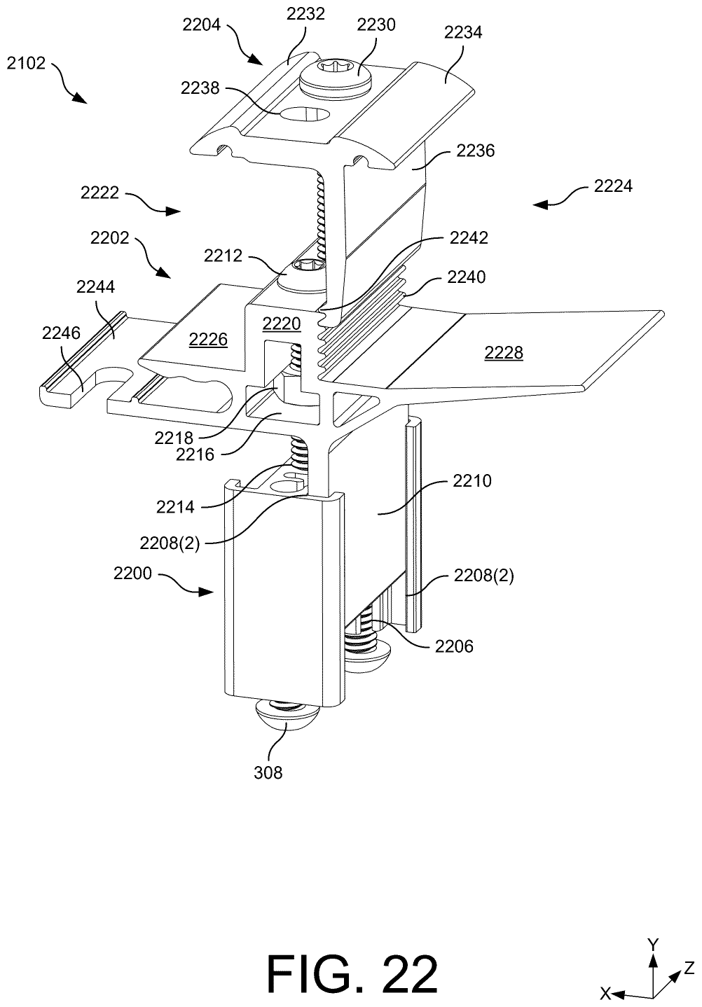

FIG. 22 illustrates an isometric view of the clamp 2102, according to an embodiment of the present disclosure. The clamp 2102 may include a base 2200, a stanchion 2202, and a bracket 2204. The base 2200 may define one or more threaded receptacles 2206 into which the fasteners 308 are disposed. For example, the base 2200 may define two of the threaded receptacles 2206 into which the fasteners 308 are threaded. The fasteners 308 may be disposed through the first slots 2106 and into the threaded receptacles 2206 to secure the base 2200 to the rail 2100. The fasteners 308 may also be pre-installed on the base 2200 and used in conjunction with the rail 1900.

The base 2200 defines grooves 2208 for attaching to the stanchion 2202. For example, the stanchion 2202 may include a vertical body 2210 (e.g., arm, leg, strut, etc.) disposed within the grooves 2208. A first side of the vertical body 2210 may be disposed in a first groove 2208(1) and a second side of the vertical body 2210 (e.g., spaced apart in the Z-direction) may be disposed in a second groove 2208(2). A fastener 2212 may be used to adjust a height of the stanchion 2202 relative to the base 2200. As will be discussed herein, the fastener 2212 may be threaded into a receptacle 2214 of the base 2200. Rotation of the fastener 2212 in a first direction (e.g., clockwise about the Y-axis) may cause the stanchion 2202 to extend from the base 2200, thereby raising the stanchion 2202 above the base 2200. Rotation of the fastener 2212 in a second direction (e.g., counterclockwise about the Y-axis) may cause the stanchion 2202 to retract into the base 2200. The sides of the vertical body 2210 may translate within the grooves 2208 as the fastener 2212 is rotated in the first direction and the second direction. Moreover, an engagement between the vertical body 2210 and the grooves 2208 may provide support to the stanchion 2202 during loads experienced by the solar panel modules 102.

The stanchion 2202 may include a channel 2216 in which a nut 2218 is disposed. The fastener 2212 may be threaded through the nut 2218 and into the receptacle 2214 of the base 2200. The nut 2218 may be retained within the channel 2216. In an embodiment, an engagement between nut 2218 and the channel 2216 may secure the stanchion 2202 in place relative (e.g., in the Y-direction) to the base 2200. The channel 2216 may be defined by a central body 2220 of the stanchion 2202.

The stanchion 2202 includes a first receptacle 2222 and a second receptacle 2224. The first receptacle 2222 may receive a first solar panel module while the second receptacle 2224 may receive a second solar panel module. The first receptacle 2222 and the second receptacle 2224 may be disposed on opposing sides of the clamp 2102. The stanchion 2202 may include a first arm 2226 (e.g., platform, shelf, etc.) on which a frame of the first solar panel module rests. The stanchion 2202 may include a second arm 2228 (e.g., platform, shelf, etc.) on which a frame of the second solar panel modules rests. The first arm 2226 and the second arm 2228 may extend on opposing sides of the central body 2220. Moreover, the vertical body 2210 may extend from the central body 2220.

The bracket 2204 may attach to the stanchion 2202 via a fastener 2230. The bracket 2204 may include a first arm 2232 and a second arm 2234 that extend from a vertical body 2236 of the bracket 2204. The first arm 2232 may engage with a top of the first solar panel module disposed within the first receptacle 2222. The second arm 2234 may engage with a top of the second solar panel module disposed in the second receptacle 2224.

The fastener 2230 may be disposed through the first arm 2232. During a tightening of the fastener 2230, the first solar panel module becomes clamped or secured between the first arm 2226 and the first arm 2232, and the second solar panel module becomes clamped or secured between the second arm 2228 and the second arm 2234.

The bracket 2204 may also include a through hole 2238 that permits access to the fastener 2212. For example, a tool (e.g., wrench, socket, driver, etc.) may be disposed through the through hole 2238 to engage with the fastener 2212. This permits the stanchion 2202 to be raised and lowered relative to the base 2200.

The central body 2220 of the stanchion 2202 may define teeth 2240 that engage with corresponding teeth 2242 on the vertical body 2236 of the bracket 2204. An engagement between one or more of the teeth 2240 and one or more of the teeth 2242 may secure a position of the bracket 2204 relative to the stanchion 2202.

The stanchion 2202 may include a third arm 2244 that extends from the central body 2220. The third arm 2244 may be located vertically below the first arm 2226. The third arm 2244 may define a slot 2246 into which a fastener is disposed for attaching one or more accessories to the clamp 2102, such as wiring harnesses, junction boxes, trays, ballasts, guards, deflectors, etc.

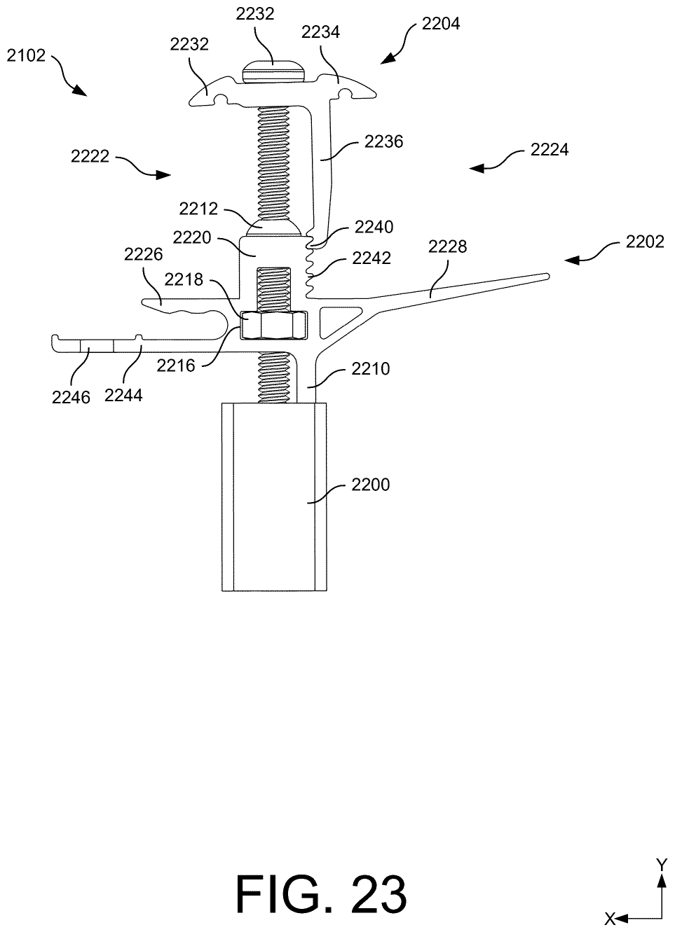

FIG. 23 illustrates a side view of the clamp 2102, according to an embodiment of the present disclosure. As introduced above, the clamp 2102 includes the base 2200, the stanchion 2202, and the bracket 2204. The vertical body 2210 of the stanchion 2202 is disposed within the grooves 2208 of the base 2200. Further, the fastener 2212 is threaded into the base 2200, via the receptacle 2214, to secure the stanchion 2202 to the base 2200. The nut 2218 is disposed within the channel 2216 to secure the fastener 2212 to the stanchion 2202 and maintain a position of the stanchion 2202 relative to the base 2200.

The stanchion 2202 includes the first arm 2226, the second arm 2228, and the third arm 2244. The first arm 2226 and the second arm 2228 may receive the first solar panel module and the second solar panel module, respectively, as the first solar panel module and the second solar panel module are disposed in the first receptacle 2222 and the second receptacle 2224. The first solar panel module and the second solar panel module are secured within the first receptacle 2222 and the second receptacle 2224 via the first arm 2232 and the second arm 2234 of the bracket 2204. The first receptacle 2222 and the second receptacle 2224 are disposed on opposing sides of the clamp 2102. The third arm 2244 includes the slot 2246 that receives a fastener for attaching an accessory to the clamp 2102. In an embodiment, the first arm 2226, the second arm 2228, and the third arm 2244 extend from the central body 2220 of the stanchion 2202.

The stanchion 2202 and the bracket 2204 engage via an interaction between the teeth 2240 and the teeth 2242. The teeth 2240 are shown disposed on the central body 2220 and the teeth 2242 are shown disposed on the vertical body 2236. The fastener 2212 further secures the bracket 2204 to the stanchion 2202.

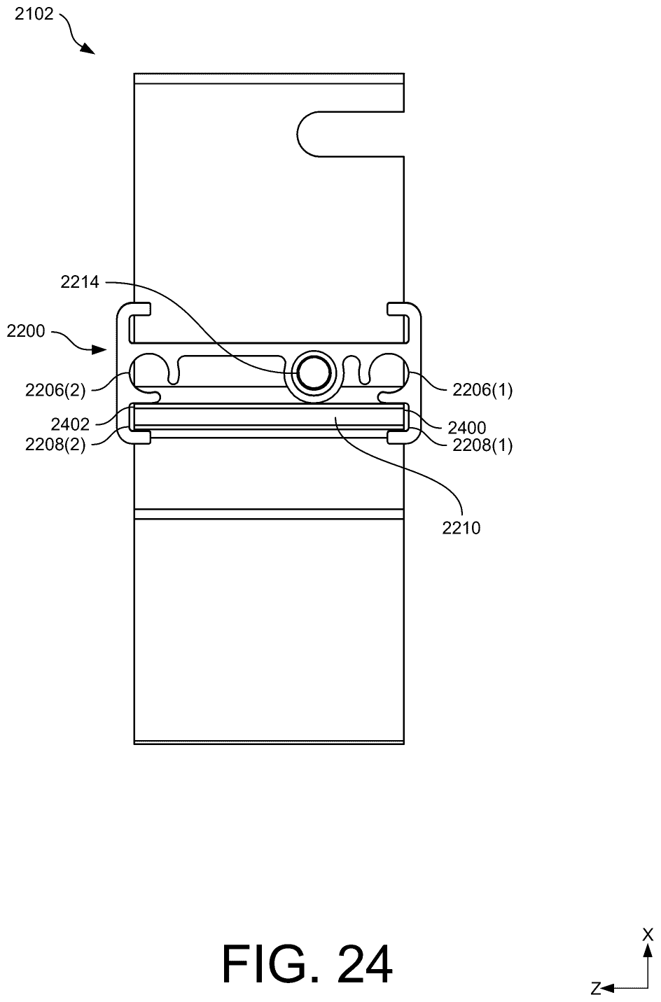

FIG. 24 illustrates a bottom view of the clamp 2102, according to an embodiment of the present disclosure. The base 2200 defines the threaded receptacles 2206 for receiving the fasteners 308, which are shown omitted in FIG. 24. A first of the fasteners 308 may thread into the threaded receptacle 2206(1) and a second of the fasteners 308 may thread into the threaded receptacle 2206(2).

The base 2200 also defines the grooves 2208 to receive the sides of the vertical body 2210 of the stanchion 2202. For example, a first side 2400 of the vertical body 2210 may be disposed or otherwise retained in the first groove 2208(1), and a second side 2402 of the vertical body 2210, spaced apart from the first side 2400 (e.g., in the Z-direction) may be disposed or otherwise retained in the second groove 2208(2). The vertical body 2210 is capable of translating within the grooves 2208 during rotation of the fastener 2212. The base defines the receptacle 2214 into which the fastener 2212 is disposed.

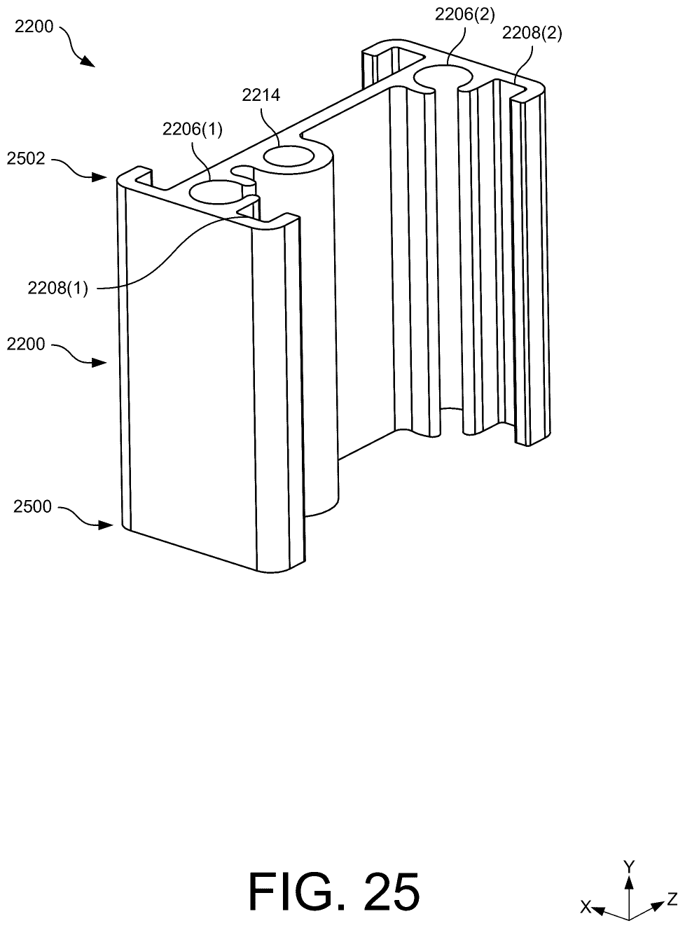

FIG. 25 illustrates an isometric view of the base 2200, according to an embodiment of the present disclosure. The base 2200 defines the threaded receptacles 2206, the grooves 2208, and the receptacle 2214. The base 2200 includes a first end 2500 and a second end 2502 spaced apart from the first end 2500 (e.g., in the Y-direction). When attached to the rail 2100 via the fasteners 308, the first end 2500 may be disposed against the top of the rail 2100. An engagement between the base 2200 and the rail 2100 may provide support to the clamp 2102.

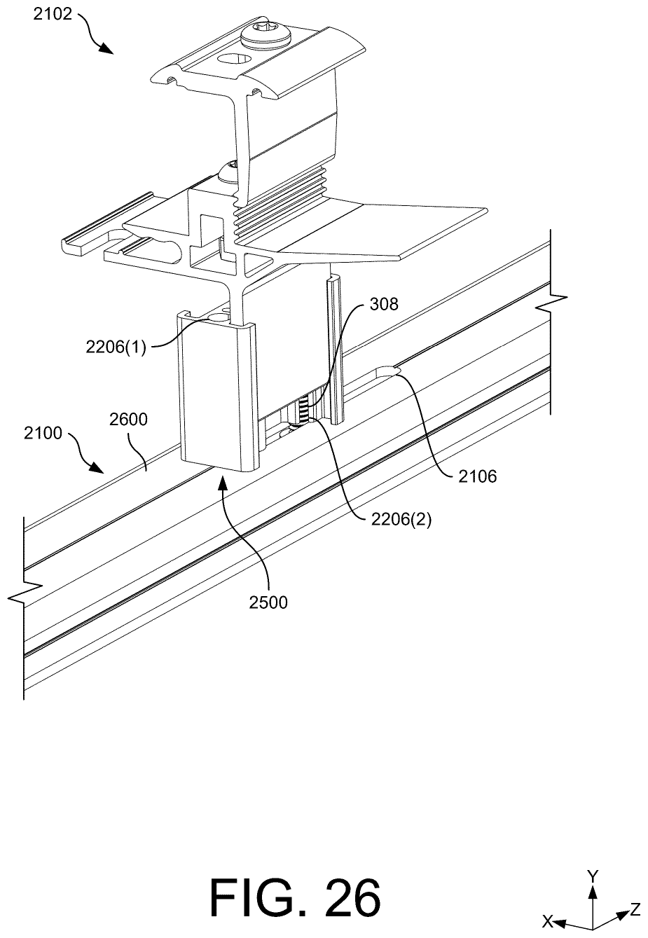

FIG. 26 illustrates an example attachment of the clamp 2102 to the rail 2100, according to an embodiment of the present disclosure. The fasteners 308 are disposed through the first slots 2106 and into the threaded receptacles 2206. As the fasteners 308 are tightened, the first end 2500 of the base 2200 is urged or brought into engagement with a top 2600 of the rail 2100. This engagement distributes loads experienced by the clamp 2102 to the rail 1900. In addition, the engagement provides support to the clamp 2102 to resist bending (e.g., about the X-axis or Z-axis).

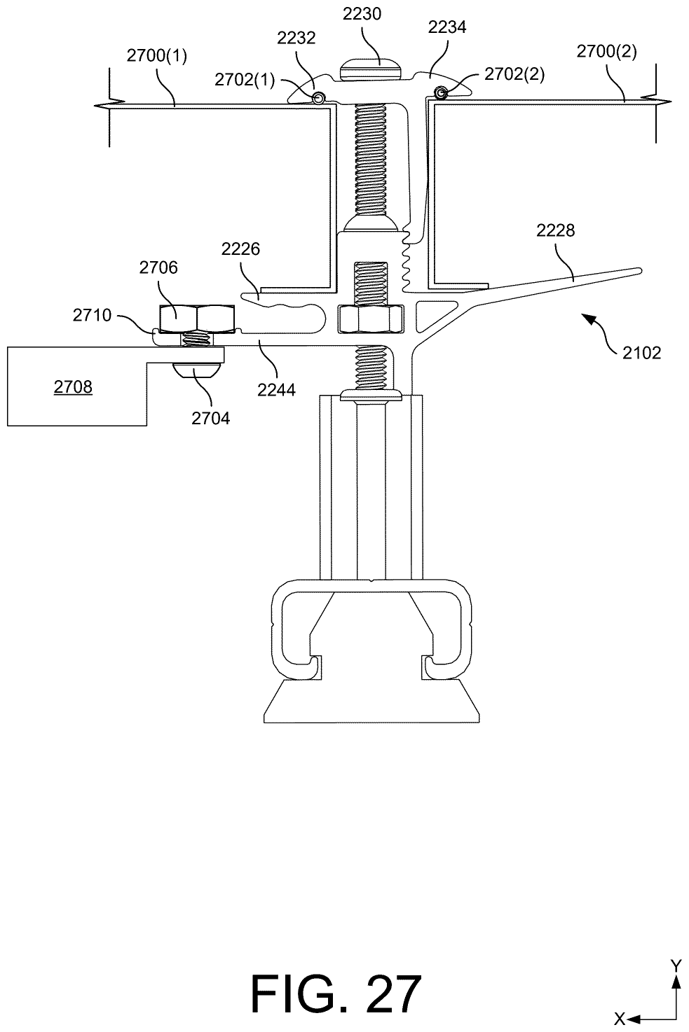

FIG. 27 illustrates an example use of the clamp 2102 to secure solar panel modules 2700 to the roof 104, according to an embodiment of the present disclosure. As shown, a first solar panel module 2700(1) may be secured within the first receptacle 2222 and a second solar panel module 2700(2) may be secured within the second receptacle 2224. A frame of the first solar panel module 2700(1) may be secured between the first arm 2226 and the first arm 2232. A frame of the second solar panel module 2700(2) may be secured between the second arm 2228 and the second arm 2234. The fastener 2230 is secured to fasten the bracket 2204 into the stanchion 1302 to secure the solar panel modules 2700 to the roof 104.

The bracket 2204 may further include a bonding pin 2702(1) on the first arm 2232 and a bonding pin 2702(2) on the second arm 2234. The bonding pins 2702 may at least partially score, indent, etc., into the frames of the solar panel modules 2700, respectively, to electrically bond the solar panel modules 102.

A fastener 2704 is shown disposed through the slot 2246 of the third arm 2244 and into a nut 2706 secured within receptacle 2214. The fastener 2704 may be used to secure an accessory 2708 to the clamp 2102. The accessory 2708 (or attachment) may represent a junction box, wiring harness, or other component (e.g., pest barrier, wind deflector, etc.). Although a particular, size, shape, and/or orientation of the accessory 2708 is shown, other variations are envisioned. Moreover, the accessory 2708 may include suitable features, such as a flange, through hole, etc., to permit the fastener 2704 to be used to secure the accessory 2708 to the clamp 2102. An engagement between the nut 2706 with arms 2710 of the receptacle 2214 may prevent rotation of the nut 2706.

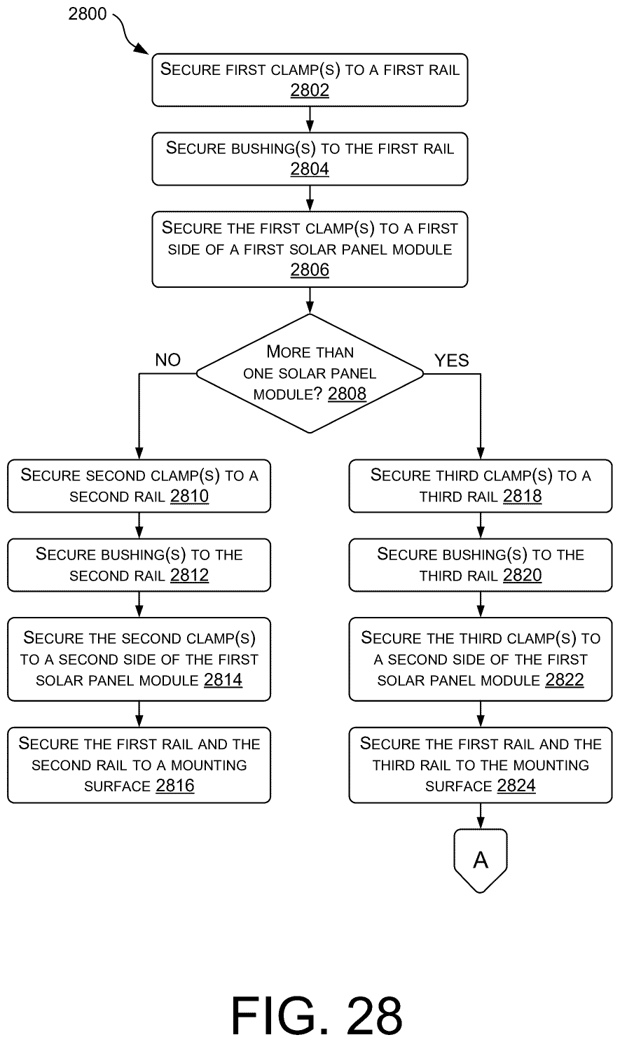

FIG. 28 illustrates an example process 2800 associated with installing one or more solar panel modules 102 onto the roof 104 using the attachment apparatus 106 and/or the attachment apparatus 108, according to an embodiment of the present disclosure. The process 2800 is described as collections of blocks. The order in which the blocks are described should not be construed as a limitation, unless specifically noted. Any number of the described blocks may be combined in any order and/or in parallel to implement the process 2800, or alternative processes, and not all of the blocks need be executed. For discussion purposes, the process 2800 is described with reference to the environments, devices, and systems described in the examples herein, such as those described with respect to FIGS. 1-27, although the process 2800 may be implemented in a wide variety of other environments and systems.

At 2802, the process 2800 may include securing first clamps to a first rail. The first clamps may represent the clamps 302 and the first rail may represent the rail 300. The fasteners 308 may be disposed through the first slots 310 and the fasteners 308 may be tightened to secure the first clamps to the first rail. Any number of the first clamps may be secured to the first rail. In an embodiment, the number of first clamps may be based at least in part on the size of the solar panel modules 102, or a number of the solar panel modules 102 attached to the roof 104. As discussed herein, the first clamps may be associated with securing a solar module disposed on an end of a row of the solar panel modules 102.

At 2804, the process 2800 may include securing bushings to the first rail. For example, the bushings 304 may be secured to the first rail. In an embodiment, the bushings 304 may be disposed within the channel 524 of the first rail, and slid along a length of the rail 300 to a position the bushings 304 adjacent to the second slots 312. An engagement between the first notch 614 and the second notch 616 of the bushings 304 within the fourth sidewall 514, the fifth sidewall 516, the first flange 518, and the second flange 520 may secure the bushings 304 to the first rail. Moreover, once the bushings 304 are disposed adjacent to the second slots 312, the fasteners 314 may be at least partially disposed through the through holes 612.

At 2806, the process 2800 may include securing the first clamps to a first side of a first solar panel module. For example, the frame of the solar panel module 102 may be disposed at least partially within the receptacle 1312. The fastener 1414 may be tightened to secure the frame of the solar panel module between the arm 1314 and the platform 1316. In an embodiment, the fasteners 1414 may not be fully tightened. This may allow the clamps 302 to be manipulated around features of the frame of the solar panel module 102. In an embodiment, the first side of the first solar panel module may associated with a length of the solar panel module 102 (e.g., portrait orientation) or a width of the solar panel module 102 (e.g., landscape orientation).

At 2808, the process 2800 may include determining whether more than one solar module are to be installed on the roof. For example, if more than one solar panel module 102 is to be installed on the roof 104, different clamps may be attached to the second side of the solar panel module 102. If at 2808, more than one solar panel module 102 is not secured to the roof 104, the process 2800 may follow the “NO” route and process to 2810.

At 2810, the process 2800 may include securing second clamps to a second rail. The second clamps may represent the clamps 302 and the second rail may represent the rail 300. The second clamps secured to the second rail may be same first clamps as secured to the first rail at 2802. That is, because only a single solar panel module 102 is installed on the roof 104, the same types of clamps (e.g., end clamps) may be secured to the solar panel module 102.

At 2812, the process 2800 may include securing bushings to the second rail. For example, the bushings 304 may be slid into an end of the second rail and aligned adjacent to the second slots 312.

At 2814, the process 2800 may include securing the second clamps to a second side of the first solar panel module. For example, a frame of the first solar panel module may be disposed in the receptacle 1312. The second side of the first solar panel module may be opposite the first side (whether in portrait or landscape orientation).

At 2816, the process 2800 may include securing the first rail and the second rail to a mounting surface. For example, the first solar panel module, with the attachment apparatuses 106 (e.g., the clamps 302, the rail 300, and the bushings 304) attached to the first side and the second side, respectively, may be installed on the roof 104. The fasteners 314 of the attachment apparatus 106 may be tightened into the roof 104. In this instance, the attachment apparatuses 106 are pre-installed to the first solar panel module, and then as an assembly, the first solar panel module, the first clamps, the second clamps, the first rail, the second rail, the bushings, etc., may be transported to the roof 104 for installation. This pre-installation of the attachment apparatuses 106 to the first solar panel module may reduce installation times on the roof 104. The attachment apparatuses 106 may be arranged parallel to the rafters 112 in the roof 104, and the fasteners 314 need not be installed into the rafters 112.

If at 2808 more than one solar panel module is to be attached to the roof 104, the process 2800 may follow the “YES” route and proceed to 2818. At 2818, the process 2800 may include securing third clamps to a third rail. The third clamps may represent the clamps 2102 and the third rail may represent the rail 2100. That is, because more than one solar panel module 102 is secured to the roof 104, the clamps 2102 are used to support the first solar panel module and an additional solar panel module, via the first receptacle 2222 and the second receptacle 2224, respectively. The third clamps may be secured to rail 2100 via the fasteners 308 disposed through the first slots 2106.

At 2820, the process 2800 may include securing bushings to the third rail. For example, the bushings 304 may be disposed in the channel 524 and slid along a length of the channel 524 to be disposed adjacent to the second slots 2108.

At 2822, the process 2800 may include securing the third clamps to a second side of the first solar panel module 102. For example, the second side of the first solar panel module may be disposed in the second receptacle 2224. The fastener 2230 may be tightened to secure the solar panel module between the second arm 2228 and the second arm 2234. In an embodiment, the fasteners 2212 may not be fully tightened to allow another solar panel module to be inserted into the first receptacle 2222.

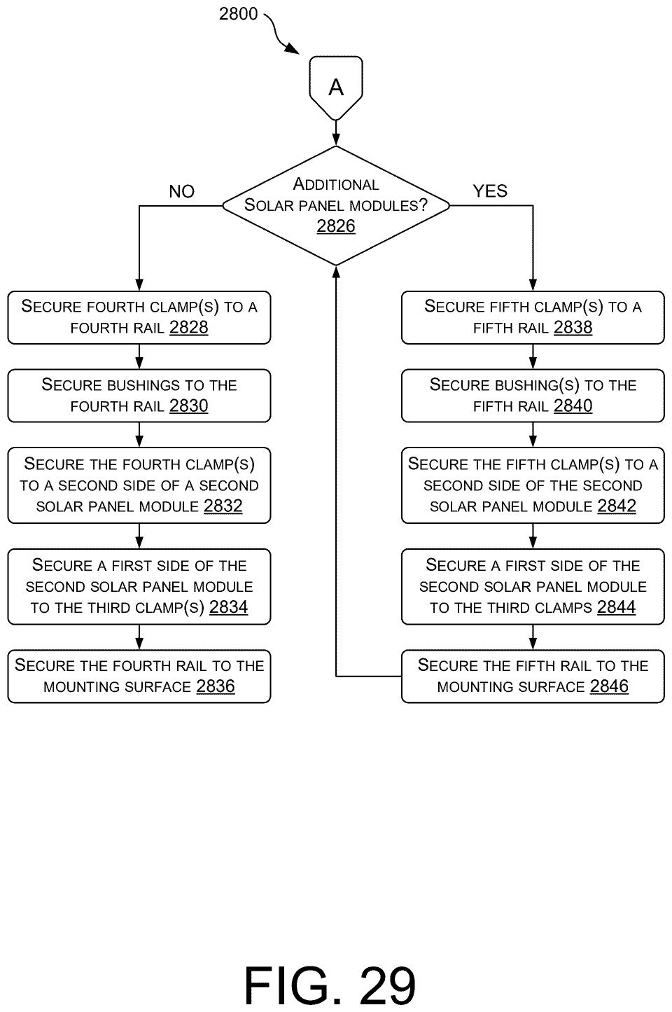

At 2824, the process 2800 may include securing the first rail and the third rail to the mounting surface. For example, with the first clamps and the third clamps secured to the first side and the second side of the first solar panel module, the first solar panel module may be transported to the roof 104. Once on the roof 104, the fasteners 314 may be used to secure the first rail and the third rail into the roof 104. From 2824, the process 2800 may proceed to “A” as discussed in FIG. 29.

From “A’ the process 2800 may proceed to 2826. At 2826, the process 2800 may include determining whether additional solar panel modules are to be installed on the roof. For example, at this point, at least two solar panels are to be installed on the roof 104, given that the third clamps (i.e., the clamps 2102) were secured to the second side of the first solar panel module. If at 2826 the process 2800 determines that no additional solar panels are not to be secured to the roof 104, the process 2800 may follow the “NO” route and proceed to 2828.

At 2828, the process 2800 may include securing fourth clamps to a fourth rail. The fourth clamps may represent the clamps 302 and the fourth rail may represent the rail 300. In this example, only two of the solar panel modules 102 are secured to the roof 104. The fourth clamps may be secured to the fourth rail using the fasteners 308.

At 2830, the process 2800 may include securing bushings to the fourth rail. For example, the bushings 304 may be slide into a channel of the fourth rail and aligned adjacent to the second slots 312.

At 2832, the process 2800 may include securing the fourth clamps to a second side of a second solar panel module. For example, the rail of the second solar panel module may be disposed within the receptacle 1312 of the fourth clamps, and the fastener 1414 may be tightened to secure the rail between the arm 1314 and the platform 1316.

At 2834, the process 2800 may include securing a first side of the second solar panel module to the third clamps on the third rail. For example, with the third clamps secured to the second side of the second solar panel module frame, the second solar panel module 102 may be transported to the roof 104. The first side of the second solar panel module may be disposed in the first receptacle 2222. The fastener 2230 may therein be tightened to clamp the second solar panel module between the first arm 2232 and the first arm 2226, as well as the second arm 2234 and the second arm 2228.

At 2836, the process 2800 may include securing the fourth rail to the mounting surface. For example, the fasteners 314 may be used to secure the fourth rail to the roof. At this point, two solar panel modules are installed on the roof 104. The first solar panel module is secured to the roof 104 via the attachment apparatus 106 and the attachment apparatus 108, while the attachment apparatus 108 is secured to the roof 104 via another of the attachment apparatus 106 and the attachment apparatus 108. This may be similar to the illustration shown in FIG. 1. The attachment apparatuses 106 are disposed on the end of the row (e.g., the first side of the first solar panel module and the second side of the second solar panel module) and the attachment apparatus 108 is disposed within a middle of the row (e.g., the second side of the first solar panel module and the first side of the second solar panel module).

If at 2826 the process 2800 determines that additional solar panel modules 102 are to be secured to the mounting surface, the process 2800 may follow the “YES” route and proceed to 2838. At 2838, the process 2800 may include securing fifth clamps to a fifth rail. The fifth clamps may represent the clamps 2102 and the fifth rail may represent the rail 2100. The fifth clamps may be secured to the fifth rail using the fasteners 308.

At 2840, the process 2800 may include securing bushings to the fifth rail. For example, the bushings 304 may be slid into a channel of the fifth rail and disposed adjacent to the second slots 2108.

At 2842, the process 2800 may include securing the fifth clamps to a second side of a second solar panel module. For example, the second side of the second solar panel module may be disposed in the second receptacle 2224 of the fifth clamp.

At 2844, the process 2800 may include securing a first side of the second solar panel module to the third clamps. For example, the first side of the second solar panel module may be disposed in the first receptacle 2222 of the third clamps. As introduced above, the third clamps may additionally support the second side of the first solar panel module. The fastener 1414 of the third clamps may be used to secure the second solar panel module to the third clamps.

At 2846, the process 2800 may include securing the fifth rail to the mounting surface. For example, the fasteners 314 may be used to secure the fifth rail to the roof 104. At this point, two solar panel modules are secured to the roof 104, and at least three solar panel modules are to be secured to the roof 104. The third solar panel module may be secured to the roof 104 via the attachment apparatus 106 or the attachment apparatus 108, depending upon whether a fourth solar panel module is to be secured to the roof 104. As such, from 2846, the process 2800 may loop to 2826.

The process 2800 therefore illustrates a pre-installation of the attachment apparatus 106 and/or the attachment apparatus 108 to the solar panel modules. Once transported to the roof 104, the fasteners 314 and the fasteners 314 may be secured into the roof 104 to secure the attachment apparatus 106 and/or the attachment apparatus 108. Although not discussed, an elevation of the solar panel modules may additionally be adjusted, accessories may be attached to the clamps, etc. In an embodiment, the attachment apparatus 106 and the attachment apparatus 108 as discussed in the process 2800 may be attached to the roof 104 parallel to the rafters 112.

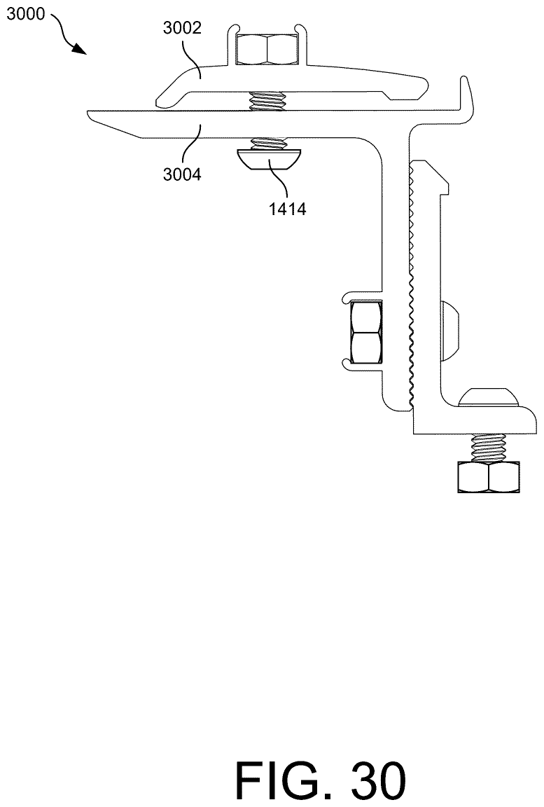

FIG. 30 illustrates a clamp 3000 that may be usable with the attachment apparatus 106, according to an embodiment of the present disclosure. The clamp 3000 may be similar to the clamp 302 as discussed above. However, as shown, compared to the clamp 302, the clamp 3000 may include a platform 3002 and an arm 3004 that are not adjoined at the first end 1412. In this instances, the platform 3002 and the arm 3004 may be separate components. The platform 3002 and the arm 3004 may connect via the fastener 1414 to secure the solar panel module 1020. In other respects, the clamp 3000 may be structurally similar to the clamp 302, and the solar panel modules 102 may attach to the clamp 3000 in a similar manner as the clamp 302.

As used herein, terms such as “attached,” “fastened,” “secured,” “disposed,” “connected,” and “coupled” (including variations thereof) are intended to be used interchangeably to refer to any form of interaction between components, whether directly or indirectly, permanently or temporarily, mechanically or otherwise. It will be understood that these terms are not intended to limit the nature of the interaction to a direct or immediate connection unless specifically stated, and may include indirect connections through one or more intermediary elements. Likewise, the terms “directly” and “indirectly” describe both physical contact between components and connections made through intermediate structures, mechanisms, or devices.

While various examples and embodiments are described individually herein, the examples and embodiments may be combined, rearranged, and modified to arrive at other variations within the scope of this disclosure.

Although the subject matter has been described in language specific to structural features and/or methodological acts, it is to be understood that the subject matter defined in the appended claims is not necessarily limited to the specific features or acts described. Rather, the specific features and acts are disclosed as illustrative forms of implementing the claims.

What is claimed is:

1. An attachment apparatus for securing a solar panel module to a surface, the attachment apparatus comprising:
a rail including:
first slots,
second slots, and
a channel;
a plurality of clamps to attach to the rail at locations corresponding to the first slots, individual clamps of the plurality of clamps including a receptacle to receive at least a portion of a solar panel module; and
a plurality of bushings to attach to the rail at locations corresponding to the second slots, the plurality of bushings being disposable at least partially within the channel, individual bushings of the plurality of bushings including one or more through holes to receive fasteners to attach the attachment apparatus to the surface.

2. The attachment apparatus of claim 1, wherein:
the individual clamps include, respectively:
a bracket having one or more teeth,
a stanchion secured to the bracket, the stanchion having one or more teeth that engage with the one or more teeth of the bracket,
a platform, and
an arm attached to the platform; and
the receptacle is defined by the platform and the arm.

3. The attachment apparatus of claim 1, wherein:
the individual clamps include, respectively:
a base,
a stanchion secured to the base, the stanchion having one or more teeth, and
a bracket secured to the stanchion, the bracket having one or more teeth that engage with the one or more teeth of the stanchion; and
the receptacle is defined by the stanchion and the bracket.

4. The attachment apparatus of claim 1, further comprising a sealant at least partially disposed within the one or more through holes.

5. The attachment apparatus of claim 1, wherein the individual clamps include a second receptacle to receive at least a portion of a second solar panel module.

6. The attachment apparatus of claim 1, wherein:
the rail includes a first end and a second end spaced apart from the first end; and
the first slots and the second slots are alternatingly disposed between the first end and the second end.

7. The attachment apparatus of claim 1, wherein the individual clamps include, respectively, an arm having a slot to receive a second fastener for attaching one or more accessories to the individual clamps.

8. An attachment apparatus comprising:
a rail including:
a first side, and
a second side;
a plurality of clamps to be disposed on the first side of the rail, individual clamps of the plurality of clamps including a stanchion that at least partially defines a receptacle to receive a solar panel module; and
a plurality of bushings to be disposed on the second side of the rail, individual bushings of the plurality of bushings including one or more through holes to receive fasteners to attach the attachment apparatus to a surface, the one or more through holes having:
a first portion with a first cross-sectional dimension, and
a second portion with a second cross-sectional dimension different than the first cross-sectional dimension.

9. The attachment apparatus of claim 8, further comprising a sealant disposed in the second portion.

10. The attachment apparatus of claim 8, wherein the stanchion at least partially defines a second receptacle to receive a second solar panel module.

11. The attachment apparatus of claim 8, wherein:
the rail includes:
first slots, and
second slots;
second fasteners are disposed through the first slots and into the individual clamps to secure the individual clamps to the rail; and
the fasteners are disposed through the second slots and into the individual bushings.

12. The attachment apparatus of claim 8, wherein:
the rail includes a channel; and
the individual bushings are at least partially disposed within the channel.

13. The attachment apparatus of claim 12, wherein:
the individual bushings include:
a first notch, and
a second notch; and
the rail includes:
a first flange at least partially disposed within the first notch, and
a second flange at least partially disposed within the second notch.

14. The attachment apparatus of claim 8, wherein at least a portion of the individual clamps include an arm to receive a second fastener for attaching an accessory to the at least the portion of the individual clamps.

15. The attachment apparatus of claim 8, wherein the rail is arranged parallel to structural members disposed beneath the surface.

16. An attachment apparatus comprising:
a rail, that when installed on a mounting surface, is arranged substantially parallel to structural members disposed beneath the mounting surface;
one or more clamps to secure to the rail, individual clamps of the one or more clamps including:
a stanchion adjustable in height relative to the rail,
a receptacle to receive at least a portion of a solar panel module, and
a first fastener, that when actuated, secures the at least the portion of the solar panel module within the receptacle; and
one or more bushings to secure to the rail, individual bushings of the one or more bushings including at least one through hole to receive a second fastener to secure the rail to the mounting surface.

17. The attachment apparatus of claim 16, wherein the one or more clamps further include a second receptacle to receive at least a portion of a second solar panel module.

18. The attachment apparatus of claim 16, wherein at least one clamp of the one or more clamps includes a slot to receive a third fastener to attach an accessory to the at least one clamp.

19. The attachment apparatus of claim 16, wherein a sealant is disposed at least partially within the at least one through hole.

20. The attachment apparatus of claim 16, wherein:
the rail includes:
a channel,
one or more first slots, individual slots of the one or more first slots corresponding to a location where the individual clamps secure to the rail, and
one or more second slots, individual slots of the one or more second slots corresponding to a location where the individual bushings secure to the rail; and
the individual bushings are at least partially disposed within the channel.
